(19) United States
(12) Patent Application Publication
(10) Pub. No.: US 2006/0195226 A1
(43) Pub. Date: Aug. 31, 2006

(54) Mobile robot system and program for controlling the same

(75) Inventors: Yoshihiko Matsukawa, Nara (JP); Masamichi Nakagawa, Osaka (JP); Kunio Nobori, Osaka (JP); Shusaku Okamoto, Kanagawa (JP)

Correspondence Address: GREGORY A. STOBBS, 5445 CORPORATE DRIVE, SUITE 400, TROY, MI, 48098, US

(73) Assignee: Matsushita Electric Industrial Co., Ltd., Osaka (JP)

(21) Appl. No.: 11/348,452

(22) Filed: Feb. 6, 2006

Related U.S. Application Data
(63) Continuation of application No. PCT/JP04/11241, filed on Aug. 5, 2004.

(30) Foreign Application Priority Data
Aug. 7, 2003 (JP) 2003-288680

(51) Int. Cl. G06F 19/00

(52) U.S. Cl. 700/245

(57) ABSTRACT

A living assistance system is provided with an information presentation device capable of directly displaying information relating to an article onto actual environment, a moving area generation unit (for generating a moving area of the robot, a grabbing feasible area generation unit for generating a grabbing feasible area of the robot, and a guide information generation unit for calculating guide information from an user to the article. The living assistance system displays information obtained by the moving area generation unit, the grabbing feasible area generation unit, and the guide information generation unit by using the information presentation device. Thus, there is provided the living assistance system that manages articles and the like in a house or the like, and can more intuitionally present attribute information to the article or information to be used for smoothly transferring the article to the user.

This is a continuation application of International Application No. PCT/JP2004/11241, filed Aug. 5, 2004.

### BACKGROUND OF THE INVENTION

The present invention relates to a mobile robot system that manages articles as an example of objects in a living environment, such as a residential environment, and more particularly, to a mobile robot system having an interface which can be easily understood by a user without imposing a burden, such as presenting information of articles that are managed and operations of the robot.

Man has so far spent much time on disposal and management of information and things. In recent years, however, most of information (images, music, documents, and the like) has been digitized, and convenience has increased about processing and circulation of information by the developments of the Internet and personal computers (PCs) so that disposal and management of the information can be carried out more freely and easily. In contrast, with respect to process (disposal and management) of things, at present, convenience has not increased sufficiently. It is true that many convenient household electrical appliances, furniture, and other equipments have been developed so as to release people from labor, such as housekeeping, to provide a more affluent life. However, looking back upon personal matters, people are still pushed around by “things”. For example, looking for a thing, arranging things neatly, separating trash, and carrying tableware.

An object of the mobile robot system of the present invention is to achieve an efficient disposal and management of things as described above. For this purpose, it is necessary to manage a location of each article automatically. Even by properly managing the location of each of articles, it becomes possible to effectively “search for a thing”. In addition, by using a robot having functions of grabbing and carrying an article in combination, it becomes possible to achieve a process for automatically moving an article, and consequently to widen the range of application of living assistance.

The following conditions are required in order to achieve such a mobile robot system.

1) Attributes of an object (kind, position, time, etc.) are always under control (sensing function).

2) Managed information can be utilized conveniently (user-friendly interface).

3) Smooth operations when moving an object (prevention of collision, etc. between a robot in the middle of moving and a man).

Conventionally, in the field where articles to be managed are unified, such as an industrial automatic warehouse system and a library, an automated system has been introduced to a certain degree, with the above-mentioned conditions being satisfied. In contrast, in places such as homes and offices where articles to be dealt have a greater degree of freedom in the environment, it is not simple to construct a system that satisfies the above-mentioned conditions. However, several attempts to clear the above-mentioned conditions have been made in homes and the like.

For example, Japanese Unexamined Patent Publication No. 2002-60024 has disclosed an article managing system provided with a storage unit that stores names of respective areas in a house. In this system, classifying codes including housing objects, objects to be housed, and independent objects (television, etc.), codes each of which indicates which area the article in question is housed in (in particular, with respect to the object to be housed, codes indicating which housing object houses the article in question), and image data are attached to articles inside a home, and by storing pieces of information of the articles in the storage unit together with those codes, the articles in the home are managed. Here, the various codes of the articles are manually inputted. In this system, the image data of the articles is synthesized with a CG image of the inside of the house displayed on a terminal screen and presented to the user. Then, referring to the image on the terminal screen, the user utilizes this system to look for articles and also to revise designing so as to fit to belongings before construction.

Moreover, Japanese Unexamined Patent Publication No. 2002-48091 has disclosed a home inventory control system that is provided with a home server having a barcode reader that acquires barcode information attached to articles in a home, a storage means that stores information of the articles based upon the barcode information, a display and input means that displays and updates information in the storage means, and a communication control means, so that the user is allowed to refer to the inventory information of articles in the home at home as well as from the outside. In this conventional technique, in comparison with the above-mentioned conventional technique, although the inputting process of article attributes is simplified by using barcodes, the position of each of the articles is not stored. For this reason, this system is not suitable for a searching process for any article as well as for a transferring process of any article. Although this system also carries out the inventory confirmation of articles on the screen of a terminal or the like in the same manner as the above-mentioned conventional technique, this system provides the screen in a table format without using a CG image or the like.

In any of the conventional techniques, since the presence or absence of any article and the existence position thereof are displayed on the terminal screen, the user has to go all the way to the installation place of the terminal. Moreover, although a virtual state is displayed on the terminal screen, the virtual screen and the appearance of the actual world tend to be somewhat different from each other. Therefore, the user tends to have the troublesomeness in finding matched portions while comparing these. In particular, when a plurality of movable objects (men, robots, etc.) are present in the same environment and want to share information on the places of articles or the like with each other, it is inconvenient for them to use terminals so as to transmit information to each other. For example, in the field of nursing the old and the physically challenged person that is expected to have further demands in the future, when, upon asking a care personnel to take a certain article, such a system requires the cared to specify the place of the article through a terminal, failing to provide an interface that is easy to use.

Moreover, in the conventional techniques, only the information of an article is presented, without transferring the article. Therefore, the subject for smoothing the transferring process is not raised. However, in the case of transferring the article, it is necessary to smooth the transferring process. For example, in the case when an article is transferred by a robot, it is necessary to preliminarily prevent collision between the robot in the middle of its movement and a man (ensuring of security), or upon delivering an article to a robot and receiving it from the robot, it is necessary to provide an assistance technique so as to carry out the delivery of the article smoothly and safely.

In order to solve the above-mentioned issues, the object of the present invention is to provide a mobile robot system for managing articles and the like in a residential environment, and exerting such a technique that attribute information of the article or information used for smoothly transferring the article is presented to the user more intuitively.

### SUMMARY OF THE INVENTION

In order to achieve the above-mentioned object, the present invention is provided with the following arrangements.

According to one aspect of the present invention, there is provided a mobile robot system for managing an article located within a living environment, comprising:

an article robot database for storing at least information relating to an article located within the living environment and information relating to a robot capable of moving inside the living environment;

an environment map information database for storing information of structures of an equipment and a space inside the living environment;

a moving plan forming means for generating moving path information of the robot based upon information of the article robot database and information of the environment map information database, prior to movement of the robot to the article or to the equipment, or during the movement thereto; and

an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,

wherein the information presentation device changes a color of the moving path or the moving occupancy area in accordance with a speed at which the robot travels.

In accordance with another aspect of the present invention, there is provided a mobile robot system for managing an article located within a living environment, comprising:

an article robot database for storing at least information relating to an article located within the living environment and information relating to a robot capable of moving inside the living environment;

an environment map information database for storing information of structures of an equipment and a space inside the living environment;

a moving plan forming means for generating moving path information of the robot based upon information of the article robot database and information of the environment map information database, prior to movement of the robot to the article or to the equipment, or during the movement thereto; and

an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,

wherein the information presentation device presents the moving path and the moving occupancy area with a color of the moving path or the moving occupancy area changed in accordance with an arrival time of the movement of the robot to the article.

In accordance with still another aspect of the present invention, there is provided a mobile robot system comprising:

an environment map information database for storing information of structures of an equipment and a space within a living environment;

a robot capable of moving within the living environment;

a moving plan forming means for generating moving path information of the robot based upon information of the environment map information database, prior to movement of the robot to an article or to the equipment, or during the movement thereto; and

an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,

wherein the information presentation device presents the moving path and the moving occupancy area with a color of the moving path or the moving occupancy area changed in accordance with a speed at which the robot travels.

In accordance with still another aspect of the present invention, there is provided a mobile robot system comprising:

an environment map information database for storing information of structures of an equipment and a space within a living environment;

a robot capable of moving within the living environment;

a moving plan forming means for generating moving path information of the robot based upon information of the environment map information database, prior to movement of the robot to an article or to the equipment, or during the movement thereto; and

an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,

wherein the information presentation device presents the moving path and the moving occupancy area with a color of the moving path or the moving occupancy area changed in accordance with an arrival time of the movement of the robot to the article.

In accordance with still another aspect of the present invention, there is provided a mobile robot system comprising:

an environment map information database for storing information of structures of an equipment and a space within a living environment;

a robot capable of moving within the living environment, which has a grabbing unit capable of grabbing an article;

a robot grabbing area generation means for generating information of a grabbing feasible area that allows the robot to grab the article as a robot grabbing feasible area based upon information of the environment map information database; and

an information presentation device for directly presenting the robot grabbing feasible area generated by the robot grabbing area generation means to inside of the living environment,

wherein the robot grabbing feasible area is directly outputted to the inside of the living environment by the information presentation device to be presented therein.

In accordance with still another aspect of the present invention, there is provided a program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to the article or to the equipment, or during the movement thereto, the program comprising:

a step of executing an operation in which, upon the movement of the robot, based upon the moving path information, the moving path and the moving occupancy area of the robot are directly presented in the living environment, with a color of the moving path or the moving occupancy area being changed in accordance with a speed at which the robot travels.

In accordance with the other aspect of the present invention, there is provided a program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to an article or to the equipment, or during the movement thereto, the program comprising:

a step of executing an operation in which, upon the movement of the robot, based upon the moving path information, the moving path and the moving occupancy area of the robot are directly presented in the living environment, with a color of the moving path or the moving occupancy area being changed in accordance with an arrival time of the movement of the robot to the article so as to be presented therein.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a block diagram that shows the entire structure of a living assistance system in accordance with a first embodiment of the present invention;

FIG. 2A is an explanatory view that explains a background differential method of the living assistance system;

FIG. 2B is an explanatory view that explains the background differential method of the living assistance system;

FIG. 2C is an explanatory view that explains the background differential method of the living assistance system;

FIG. 2D is an explanatory view that indicates a room and cameras and the like used for the background differential method in FIGS. 2A to 2C;

FIG. 3A is a conceptual view that shows a state prior to arranging neatly, in which examples of the structure of article data and the contents of description of the living assistance system are shown;

FIG. 3B is a conceptual view that shows a state after arranging neatly, in which examples of the structure of article data and the contents of description are shown;

FIG. 4A is a schematic view that shows an image of a certain environment in the living assistance system, which is picked up at certain time;

FIG. 4B is a schematic view that shows an image of a certain environment in the living assistance system, which is picked up at time different from FIG. 4A;

FIG. 5 is a conceptual view that shows the data structure of a mobile object and an example of the contents of description of the living assistance system;

FIG. 6A is a view that shows an actual state that explains an environmental map information database in the living assistance system;

FIG. 6B is a view of a three-dimensional model that explains the environmental map information database in the living assistance system;

FIG. 6C is a view of a plane model of FIG. 6A that explains the environmental map information database in the living assistance system;

FIG. 7 is a view that shows one example of data in the environmental map information database in the living assistance system;

FIG. 8A is a view that shows one example of a piece of equipments and equipment attribute data in the living assistance system;

FIG. 8B is a view that that shows one example of a piece of equipments and equipment attribute data in the living assistance system;

FIG. 9 is a flow chart that shows operations of a moving area generation means in the living assistance system;

FIG. 10A is an explanatory view that indicates the generation of a moving area image of a robot in the living assistance system;

FIG. 10B is an explanatory view that shows the moving area image of the robot in the living assistance system;

FIG. 11 is an explanatory view that indicates the generation of a moving area of the robot in the living assistance system;

FIG. 12A is a perspective view that indicates the generation of a grabbing feasible area of the robot in the living assistance system;

FIG. 12B is a side view that indicates the generation of the grabbing feasible area of the robot in the living assistance system;

FIG. 13A is an explanatory view that shows an example of presentation used when guide information of the living assistance system is shown to actual environment;

FIG. 13B is an explanatory view that shows an example of presentation used when guide information of the living assistance system is shown to actual environment;

FIG. 14 is a view that shows equipment operation commands stored in an equipment operation information storage unit of the living assistance system in a table format;

FIG. 15 is a perspective view that shows a structure of the robot in the living assistance system;

FIG. 16 is a view that shows an example of a list of robot control commands stored in a robot control command database in the living assistance system;

FIG. 17A is a view that shows a display example of a moving area of the robot when an information presentation device is installed on the environment side of the living assistance system;

FIG. 17B is a view that shows a display example of a moving area of the robot when the information presentation device is installed on the robot side of the living assistance system;

FIG. 18A is an explanatory view that shows a case in which moving paths of the robot are drawn by solid lines or dot lines in another display mode of a moving area image of the robot in the living assistance system;

FIG. 18B is an explanatory view that shows a case in which a moving occupancy area of the robot is drawn according to a degree of danger in still another display mode of the moving area image of the robot in the living assistance system;

FIG. 18C is an explanatory view that shows a case in which a moving occupancy area of the robot is drawn according to the arrival time or the speed of the robot in still another display mode of the moving area image of the robot in the living assistance system;

FIG. 18D is an explanatory view that shows a state in which the robot has progressed to the middle in FIG. 18B in still another display mode of the moving area image of the robot in the living assistance system;

FIG. 19A is a plan view that shows an occupancy area of a holding portion from the upper side of the robot as a living assistance feasible area, which explains the living assistance feasible area of the robot in the living assistance system;

FIG. 19B is a perspective view that shows a holding portion by the robot as a living assistance feasible area, which explains the living assistance feasible area of the robot in the living assistance system;

FIG. 20 is an explanatory view that shows a state in which information written on an electronic tag placed on the bottom face of a pet bottle is read by a tag reader of a refrigerator;

FIG. 21 is an explanatory view that shows a case in which operation programs of a robot arm and a hand are prepared as equipment attribute data;

FIG. 22 is a view that shows an example of the operation program of the robot arm and the hand of FIG. 21; and

FIG. 23 is a view that shows an example of a display mode of articles housed inside a piece of equipments in the living assistance system.

### DETAILED DESCRIPTION OF THE PREFERRED EMBODIMENTS

Before the description of the present invention proceeds, it is to be noted that like parts are designated by like reference numerals throughout the accompanying drawings.

Prior to explaining embodiments of the present invention, the following description will discuss various aspects thereof.

In accordance with a first aspect of the present invention, there is provided a mobile robot system for managing an article located within a living environment, comprising:

an article robot database for storing at least information relating to an article located within the living environment and information relating to a robot capable of moving inside the living environment;

an environment map information database for storing information of structures of an equipment and a space inside the living environment;

a moving plan forming means for generating moving path information of the robot based upon information of the article robot database and information of the environment map information database, prior to movement of the robot to the article or to the equipment, or during the movement thereto; and

an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,

wherein the information presentation device changes a color of the moving path or the moving occupancy area in accordance with a speed at which the robot travels.

In accordance with a second aspect of the present invention, there is provided a mobile robot system for managing an article located within a living environment, comprising:

an article robot database for storing at least information relating to an article located within the living environment and information relating to a robot capable of moving inside the living environment;

an environment map information database for storing information of structures of an equipment and a space inside the living environment;

a moving plan forming means for generating moving path information of the robot based upon information of the article robot database and information of the environment map information database, prior to movement of the robot to the article or to the equipment, or during the movement thereto; and

an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,

wherein the information presentation device presents the moving path and the moving occupancy area with a color of the moving path or the moving occupancy area changed in accordance with an arrival time of the movement of the robot to the article.

In accordance with a third aspect of the present invention, there is provided a mobile robot system comprising:

an environment map information database for storing information of structures of an equipment and a space within a living environment;

a robot capable of moving within the living environment;

a moving plan forming means for generating moving path information of the robot based upon information of the environment map information database, prior to movement of the robot to an article or to the equipment, or during the movement thereto; and

an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,

wherein the information presentation device presents the moving path and the moving occupancy area with a color of the moving path or the moving occupancy area changed in accordance with a speed at which the robot travels.

In accordance with a fourth aspect of the present invention, there is provided a mobile robot system comprising:

an environment map information database for storing information of structures of an equipment and a space within a living environment;

a robot capable of moving within the living environment;

a moving plan forming means for generating moving path information of the robot based upon information of the environment map information database, prior to movement of the robot to an article or to the equipment, or during the movement thereto; and

an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,

wherein the information presentation device presents the moving path and the moving occupancy area with a color of the moving path or the moving occupancy area changed in accordance with an arrival time of the movement of the robot to the article.

In accordance with a fifth aspect of the present invention, there is provided the mobile robot system according to the third or fourth aspect, wherein

the information presentation means comprises:

a projection device for projecting an image pattern to the inside of the living environment; and

an adjusting means for providing an image pattern that is projected based upon the moving path information in such a manner that the path information and the moving occupancy area of the robot projected by the projection device based upon the moving path information and the moving path and the moving occupancy area through which the robot actually travels are made coincident with each other.

In accordance with a sixth aspect of the present invention, there is provided a mobile robot system comprising:

an environment map information database for storing information of structures of an equipment and a space within a living environment;

a robot capable of moving within the living environment, which has a grabbing unit capable of grabbing an article;

a robot grabbing area generation means for generating information of a grabbing feasible area that allows the robot to grab the article as a robot grabbing feasible area based upon information of the environment map information database; and

an information presentation device for directly presenting the robot grabbing feasible area generated by the robot grabbing area generation means to inside of the living environment,

wherein the robot grabbing feasible area is directly outputted to the inside of the living environment by the information presentation device to be presented therein.

In accordance with a seventh aspect of the present invention, there is provided the mobile robot system according to any one of the first through sixth aspects, wherein the information presentation device is installed in the robot.

In accordance with an eighth aspect of the present invention, there is provided the mobile robot system according to any one of the second through seventh aspects, wherein the equipment is prepared as an equipment for carrying out predetermined process on the article, and for automatically carrying out the predetermined process on the article when, after the equipment has been specified as a destination position of the article, the article is transferred to the equipment.

In accordance with a ninth aspect of the present invention, there is provided the mobile robot system according to any one of the first through eighth aspects, wherein the robot comprises an action plan forming means for forming an action plan which, when a sequence of operations are specified, is used for continuously carrying out the sequence of operations, and the robot is capable of automatically executing the sequence of operations in accordance with the action plan.

In accordance with a 10th aspect of the present invention, there is provided a program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to the article or to the equipment, or during the movement thereto, the program comprising:

a step of executing an operation in which, upon the movement of the robot, based upon the moving path information, the moving path and the moving occupancy area of the robot are directly presented in the living environment, with a color of the moving path or the moving occupancy area being changed in accordance with a speed at which the robot travels.

In accordance with an 11th aspect of the present invention, there is provided a program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to an article or to the equipment, or during the movement thereto, the program comprising:

a step of executing an operation in which, upon the movement of the robot, based upon the moving path information, the moving path and the moving occupancy area of the robot are directly presented in the living environment, with a color of the moving path or the moving occupancy area being changed in accordance with an arrival time of the movement of the robot to the article so as to be presented therein.

In accordance with the present invention, the information presentation device directly outputs information concerning the article to the inside of the living environment and then presents the information therein so that the user is allowed to recognize the information concerning the article intuitionally. It is not necessary for the user to move to the place of the terminal screen so that the user is allowed to recognize the information on that spot; therefore, it becomes possible to more effectively carry out process (disposal and management) or management on the article, and consequently to conduct a living assistance operation efficiently.

Here, by designing the information presentation device so as to draw the user's attention to the article, the user is allowed to more easily recognize the information concerning the article.

With an arrangement in which, while the mobile object is moving, the occupancy area is directly displayed inside the living environment, it becomes possible to preliminarily avoid a collision between the mobile object during the movement and the user, and consequently to more smoothly move the mobile object. Moreover, upon allowing the mobile object to carry out a living assistance operation on the user, it is necessary to specify the area. For example, in the case when the mobile object that transfers the article and a man transfer and receive the article, both of the two can directly display the delivery area inside the living environment so that the man can transfer the article to the robot or receive the article from the robot smoothly as well as safely.

Referring to the figures, the following description will discuss embodiments of the present invention in detail.

First, the entire structure of a living assistance system in accordance with one embodiment of the present invention is explained, and the operations of the living assistance system are then explained together with specific examples.

Entire Structure of Living Assistance System

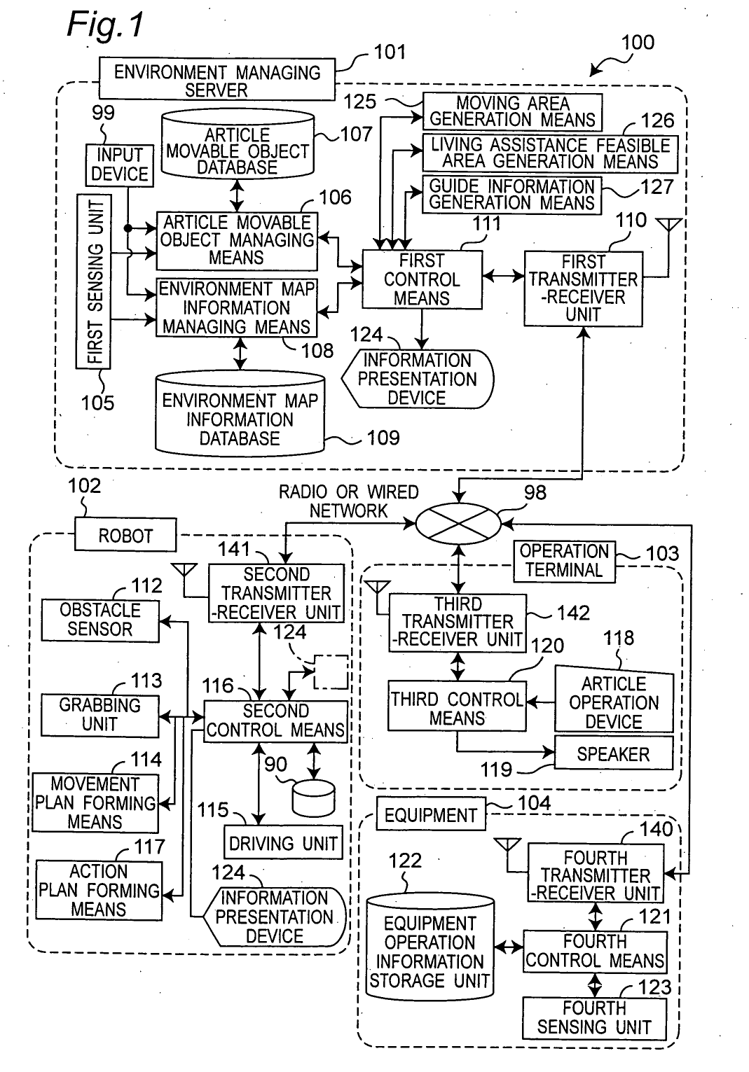

FIG. 1 is a block diagram that shows an example of the entire structure of a living assistance system 100 in accordance with the embodiment. The living assistance system 100 is mainly divided into four sub-systems, that is, an environment managing server 101 (hereinafter, referred to simply as server); a robot 102 that is one example of a mobile object for transferring an article forming an example of an object inside a living environment, such as a residential environment; an operation terminal 103; and an equipment 104.

The following description will discuss the environment managing server 101, the equipment 104, the operation terminal 103, and the robot 102 successively, with respect to their sub-system structures and operations.

Environment Managing Server

The environment managing server 101, which is the first sub-system, is provided with: a first sensing unit 105 for detecting the states inside a living environment, for example, a residential environment (hereinafter, referred to simply as environment); an article mobile object managing means 106 for managing objects located inside the environment, for example, an article and a mobile object (for example, a man, a robot, or the like) based upon the detected states; an article mobile object database 107 that is connected to the article mobile object managing means 106, for storing information concerning the article and the mobile object, used for managing the article and the mobile object as data; an environment map information managing means 108 that is connected to the first sensing unit 105, for storing information relating to the entire environment; an environment map information database 109 that is connected to the environment map information managing means 108, for storing information relating to the entire environment, used for managing the information relating to the entire environment, as data; an information presentation (indication) device 124 for presenting (indicating) information to the actual environment; a moving area generation means 125 for generating data of a moving area of the robot 102; a living assistance feasible area generation means 126 for generating a living assistance feasible area which corresponds to commonly shared area information shared with the robot 102 and a man (a habitant inside the living environment) who requires for a living assistance operation; a guide information generation means 127 for calculating guide information used for guiding the user to the target article to generate the guide information; a first transmitter-receiver unit 110 for receiving an inquiry concerning data stored in the article mobile object database 107, the environment map information database 109, and the like from the outside, and transmitting the corresponding information to the outside in response to the inquiry, and a first control means 111 for controlling the article mobile object managing means 106, the environment map information managing means 108, and the first transmitter-receiver unit 110 respectively so that for example, when the first transmitter-receiver unit 110 receives the inquiry concerning the data stored in the article mobile object database 107, the environment map information database 109, and the like from the outside, predetermined operation controlling processes are carrying out, and also carries out operation controlling processes to transmit information from the first transmitter-receiver unit 110 to the outside based upon the results of the predetermined operation controlling processes. The states inside the environment detected by the first sensing unit 105 include at least the positions and the orientations of the article and the mobile object (a man, a robot, or the like) located inside the environment for each of the time, and information inherent to the article and the mobile object (shape or producer's information used for inquiring information such as the shape). Moreover, with respect to the shared area information that includes information of a two-dimensional shared area and information of a three-dimensional shared space, for example, the information presentation device can present a two-dimensional shared area information. As will be described later, reference numeral 99 represents an input device, such as a keyboard, a mouse, and a touch panel, that allows the user to carry out a manual inputting operation, which is connected to the article mobile object managing means 106 and the environment map information managing means 108, so that it is possible to manage the objects located inside the environment that correspond to information stored in the article mobile object database 107, for example, an article and a mobile object, based upon the manually inputted information, and also to manage the information of the entire environment except for the article.

Here, the residential environment in the present embodiment includes, for example, a house, an office, and a public facility, each means an environment in which a man and an article are mutually located in association with each other.

The environment map information is composed of structural information of a room (a “space” formed by walls, a floor, and a ceiling) that is one example of the environment, and structural information of objects (immovable objects), such as furniture and large-size electric appliances (“equipments” 104 such as a refrigerator, a microwave oven, a clothes washer, a dish washer-dryer, and the like) placed inside the room, that hardly move normally. The structural information means area information (for example, positional coordinates information of apexes of a circumscribing polygonal shape of the corresponding face) of a face (for example, a floor in the case of a room and a shelf in the case of an equipment) capable of allowing another object to be put thereon, which exists on at least the inside or the upper portion of each of spaces occupied by the immovable objects or the inside and the upper portion of each of the equipments. The area information means information of an area indicated by coordinate-system information and display information or the like derived from its shape or the like.

The following description will explain each of the constituent elements of the environment managing server 101 in succession.

<First Sensing Unit>

The first sensing unit 105 always monitors the positions and states of all the monitoring subjects located within an operation environment (for example, a house, an office, a store, and the like) serving as one example of the environment, that is, articles, furniture, a man, a robot 102, and the like located within the environment. Moreover, when a new article is brought into the environment by a man, a robot 102, or the like, the first sensing unit 105 also detects the article.

With respect to a specific structure of the first sensing unit 105, although not particularly limited, for example, a device using an image sensor, a device using an electronic tag, or the like is preferably utilized. In this case, the device using an image sensor and the device using an electronic tag and methods thereof will be discussed as the specific example of the device and method for detecting an article and a mobile object.

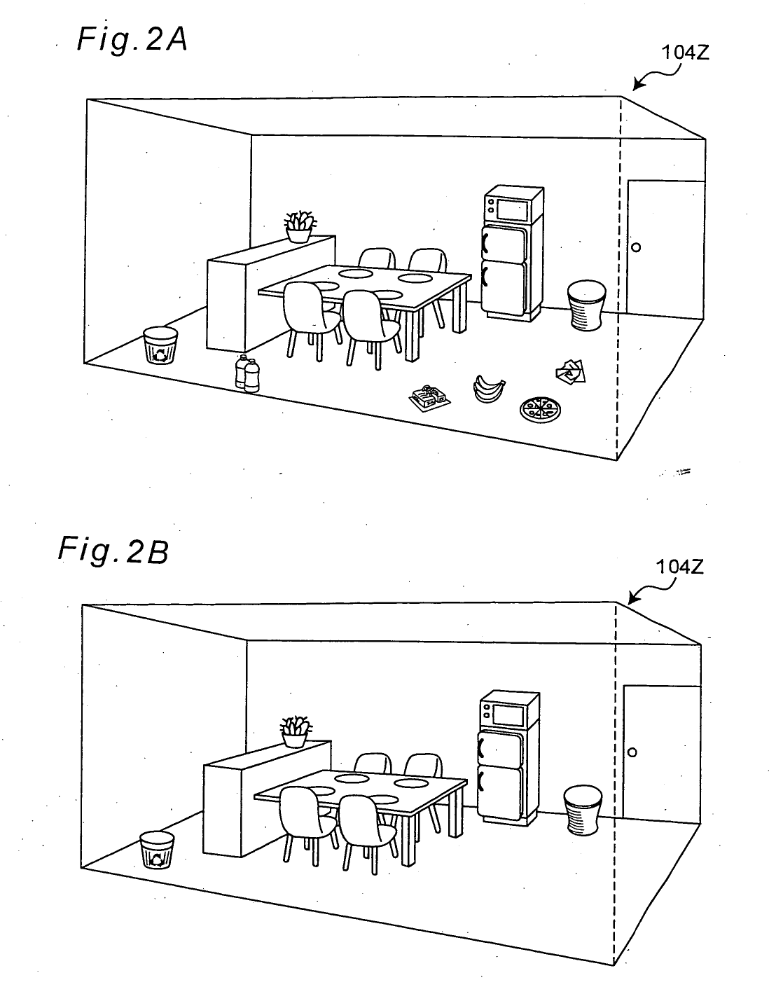

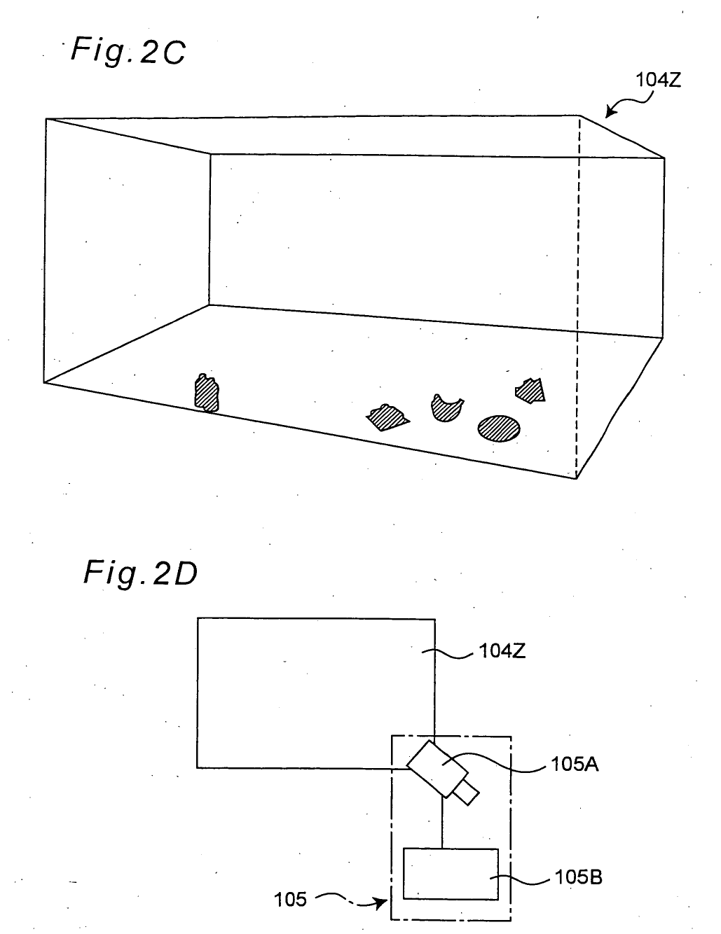

First, the following description will discuss the method in which an image sensor is used. With respect to the type of the image sensor used here, although not particularly limited, for example, a camera (image sensor) 105A may be preferably used as one example of an image-pickup means, which can effectively monitor a wide range such as the inside of a room by using fewer equipments. In other words, as shown in FIG. 2D, the camera 105A may be secured to and installed at a place such as a ceiling or a wall of a room 104Z inside a house so that a detection process and the like may be carried out on an article by using picked-up images thereof.

With respect to a general method for detecting the article by using images of the camera 105A installed inside the environment, a background differential method has been known. The background differential method refers to a method in which: a model image is preliminarily prepared as a background, and by taking a difference between the current inputted image and the model image, a subject is obtained from the images. In the present embodiment, an object of the first sensing unit 105 of the present embodiment is to detect and monitor an article and a mobile object inside the environment. For this reason, for example, in the case when no environmental variations occur, a single image in which no articles or the like exist in the environment may be used as the model image. In contrast, in the case when there are severe environmental variations, an image obtained by averaging images continuously picked up during a certain period of time may be used.

FIGS. 2A to 2D are supplementary views that explain the background differential method more specifically, and FIG. 2B shows an example of the model image. FIG. 2A is a view that shows an input image picked up at a certain point of time by using the same camera 105A as the camera 105A picked up the image of FIG. 2B, and FIG. 2C is a view that shows an example of a background differential image obtained by subtracting the model image of FIG. 2B from the input image of FIG. 2A. As clearly indicated by FIG. 2C, only the portion having a difference between the input image and the model image is raised from the background differential image. In this manner, in the background differential method, only respectively taking out the portions raised from the background differential image, the article within the environment is detected. FIG. 2D is an explanatory view that shows a relationship between the first sensing unit 105 including the camera 105A used in the background differential method and the room 104Z. Here, the number of the cameras to be used may be one; however, by using two, three, or more cameras, a shape and orientation information of an article may be obtained through a three-dimensional measuring technique by the use of stereoscopic views.

Therefore, in this example, the first sensing unit 105 is constituted by the camera (image sensor) 105A and an operation unit 105B that is connected to the camera 105A and capable of executing the background differential method and outputting the results of operations to the article mobile object managing means 106 and the environment map information managing means 108.

Next, the following description will discuss a detection method for an article using an electronic tag. In recent years, methods of detecting the position of an article or a mobile object by using electronic tags have been developed. Almost all of those methods may be applied to the present embodiment, and, for example, a technique disclosed in Japanese Unexamined Patent Publication No. 2000-357251 can be applied to the present embodiment. More specifically, by using three tag readers attached to the inside of a room, the position and ID of an article can be detected by using a 3-points measuring method based upon intensities of electric waves of electronic tags (having the same article ID) attached to an article.

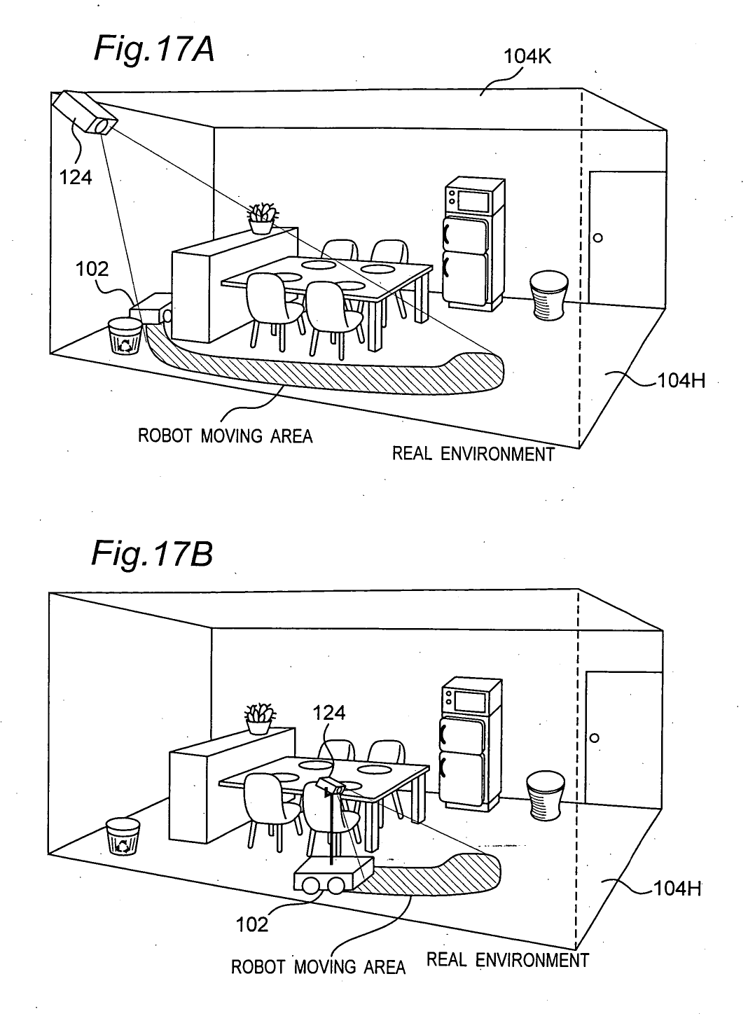

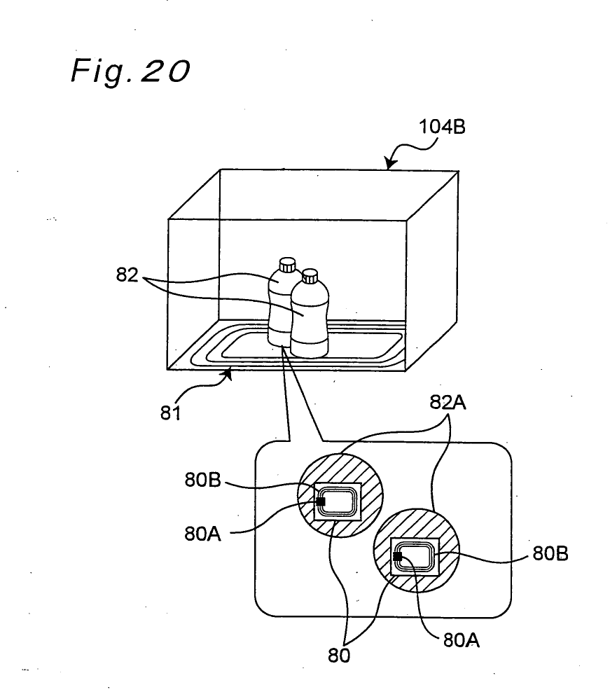

Here, as shown in FIG. 20, an electronic tag 80 is a device constituted by an IC 80A that stores data and an antenna 80B capable of transmitting data through radio, and a device 81, referred to as a reader-writer, is used for writing information onto the IC 80A of the electronic tag 80 and for reading information written in the IC 80A. FIG. 17 shows a state in which an electronic tag 80 is placed on a bottom face 82A of a pet bottle 82 and information written in the IC 80A of the electronic tag 80 is read by a reader-writer (one example of a tag reader) 81 of a refrigerator 104B.

Attribute data that feature an article, that is, data of type, year, month, and date of production, shape, weight, image of the article, trash separation information, etc. can be stored in the IC 80A of the electronic tag. The IC 80A of the electronic tag is allowed to store such data, and by reference to the data freely, it becomes possible to carry out higher-degree article managements. With this arrangement, for example, the shape and weight may be utilized upon grabbing or placing the article, the year, month, and date of production may be used for managements of sell-by date, and the kind of the article can be used as a retrieving key for a searching object; thus, these are greatly beneficial to the user. Moreover, only a commodity code (the same as barcode) standardized in the industrial field may be stored in the IC 80A of an IC tag 80 in itself, and the attribute data of the article may be inquired to the producer by using an external server that makes the commodity code associated with the attribute data and a communication means such as the Internet. Moreover, the IC 80A of the electronic tag 80 may store past information, such as past position history (or history of other attribute data) and history of past information that might be different from the current information (for example, information such as weight, image, shape, and the like) in addition to the past position, so that articles that existed in the past may be examined by using information such as the time, position, and other attribute data.

Thus, in this example, as shown in FIG. 17, the first sensing unit 105 is constituted by the electronic tag 80 constituted by the IC 80A and the antenna 80B and the reader-writer 81 that is connectable to the electronic tag 80 through radio, and capable of outputting to the article mobile object managing means 106 and the environment map information managing means 108.

The above-mentioned description has explained the detection methods of the article and the mobile object in which the camera and the electronic tag are respectively used, as specific examples of the sensing technique; however, of course, the first sensing unit 105 may be designed to use a method other than these. The first sensing unit 105 is formed so as to include at least one or more of the camera, the electronic tag, and other sensors.

Upon detection of a new article or mobile object by the first sensing unit 105, the corresponding information (for example, attribute data of the new article or mobile object) is registered/updated in the article mobile object database 107 through an article mobile object managing means 106 described later. Moreover, the first sensing unit 105 may be installed in the robot 102. Since the robot 102 can move inside the room that is one example of the environment, it is allowed to detect articles or men that cannot be covered by the first sensing unit 105 attached to the room. The absolute position and orientation of the robot 102 in the room are detected by the first sensing unit 105 of the environment managing server 101 and the relative position, orientation, and other information of an article viewed from the robot 102 are detected by a camera and a tag reader attached to the robot 102; thus, the information of the article can be acquired by installing the sensing means in the robot 102.

<Article Mobile object Database>

The article mobile object database 107 is a database for storing data as to when and where, what kind of article is placed. Referring to figures, the following description will discuss the database in detail.

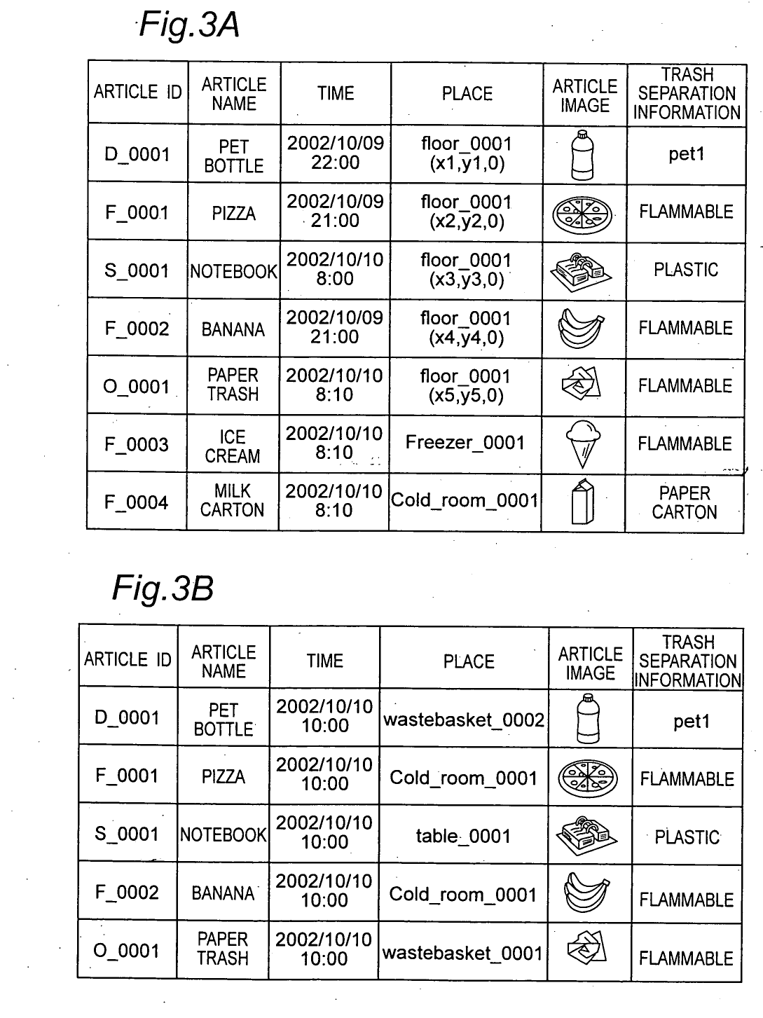

FIGS. 3A and 3B are conceptual views that show a structural example and an example of the contents of description of data in the article mobile object database 107. FIGS. 3A and 3B show the same structures with only the contents thereof being different from each other. The reason that FIGS. 3A and 3B show two types of databases is because an attempt is made to explain the state in which the contents of data are changed as time elapses.

In the present embodiment, each of article data forming the article mobile object database 107 has the following five attributes, that is, 1) article ID, 2) article name, 3) time, 4) place, and 5) article image.

1) Article ID: an ID used for identifying individual articles. Even in the case of the articles of the same kind, when those are physically different, those have to be dealt as different articles. For this reason, different IDs are assigned thereto, even if they are articles of the same kind. For example, when there are two pet bottles, two article IDs “D#0001” and “D#0002” are respectively added thereto.

2) Article name: a name that represents the kind of the corresponding article. Different from the above-mentioned article ID, the same name is used when the kind is the same. For example, “pet bottle” and “pizza” are listed.

3) Time: the time at which the article is operated (used or transferred) in the latest. For example, “2002/10/10 10:00” refers to 10:00 a.m. on the 10th of October in 2002.

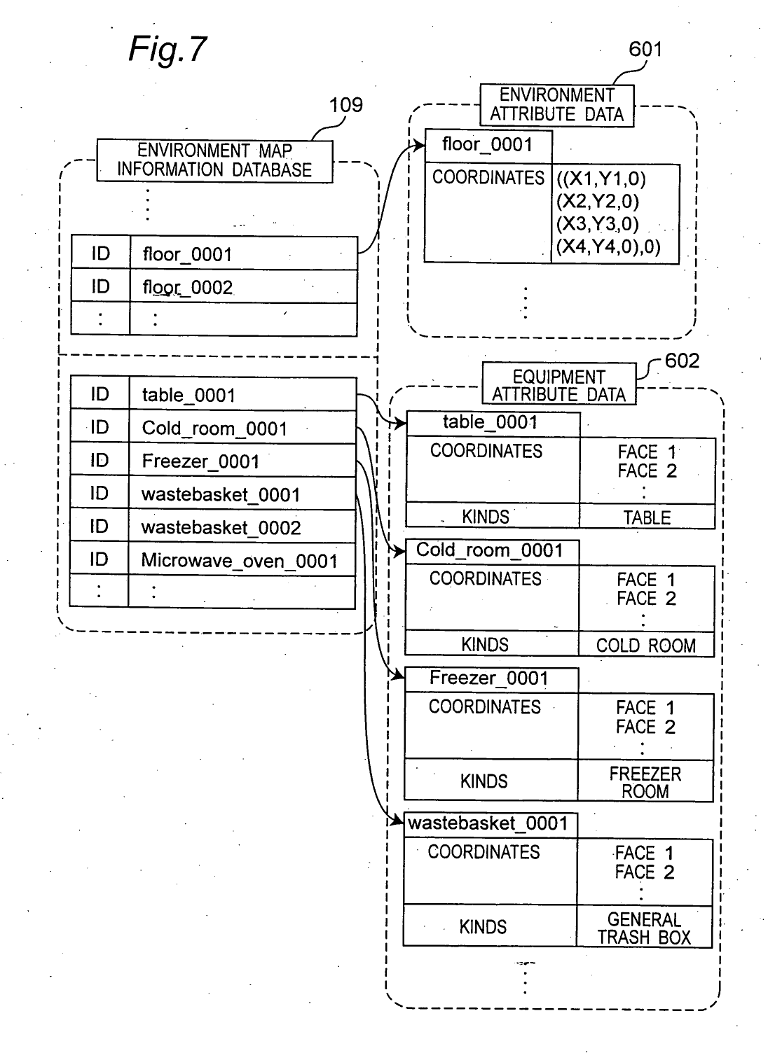

4) Place: the place to which the corresponding article was transferred when the article was operated (used or transferred) in the latest. The place is specified by environment attribute data 601 or an ID number of equipment attribute data 602 registered in an environment map information database 109, which will be described later (see FIG. 7). Here, with respect to an article on which it is difficult or impossible to specify the spatial position only by the use of the ID number, coordinate values of the article are set. For example, when the place is given as “cold room” or “freezer room”, it is specified that the article exists in it only based upon the name so that no coordinate values are specified (for example, “cold room” is indicated by “Cold_room#0001” and “freezer room” is indicated by “Freezer#0001”). In contrast, in the case when a specified place covers a wide range so that the specific existence position of an article is not specified only by its name of the place, such as “floor” “floor#0001”, coordinate values used for specifying the position are added thereto (for example, “floor#0001(x1, y1, 0)” is added to pet bottle “D#0001”, and “floor#0001(x2, y2, 0) is added to pizza “F#0001”). The initial setting and update upon transferring of the value of existence position of an article and the assignment of the coordinate values used as additional information are preferably carried out automatically by the operation unit 105B of the first sensing unit 105. Here, these processes may of course be manually carried out. The determination as to whether or not coordinate values are added upon indicating the place of the article is determined based upon functions of the robot 102 for grabbing and transferring the article. In the case when, for example, the robot 102 whose functions are very low is used to grab an article located inside a cold room, if accurate positional coordinate values are required, places (coordinate values) of articles inside the cold room may be assigned.

5) Article image: an image of the corresponding article.

The above-mentioned description has exemplified a case in which five attributes are used to discriminate the features of respective articles; however, other attributes may of course be used, if necessary. For example, a three-dimensional shape of an article, an accurate position/orientation data (not shown) of an article, etc. may be assigned as attributes. By assigning these attributes, the grabbing process for an article of the robot 102 may be carried out more easily. Moreover, the time, place, and article image may be recorded for every time, and held as history. Thus, the position of an article at the point of past time may be indicated and the image thereof may be displayed.

Here, required article attributes are preferably prepared at least as the article ID, time (time of day), and position (place). When the article ID is found, the other attributes may be inquired from the producer through the Internet.

The following description will discuss the state in which the contents of data are changed as the time elapses, while comparing the contents of the article mobile object database 107 with the actual state.

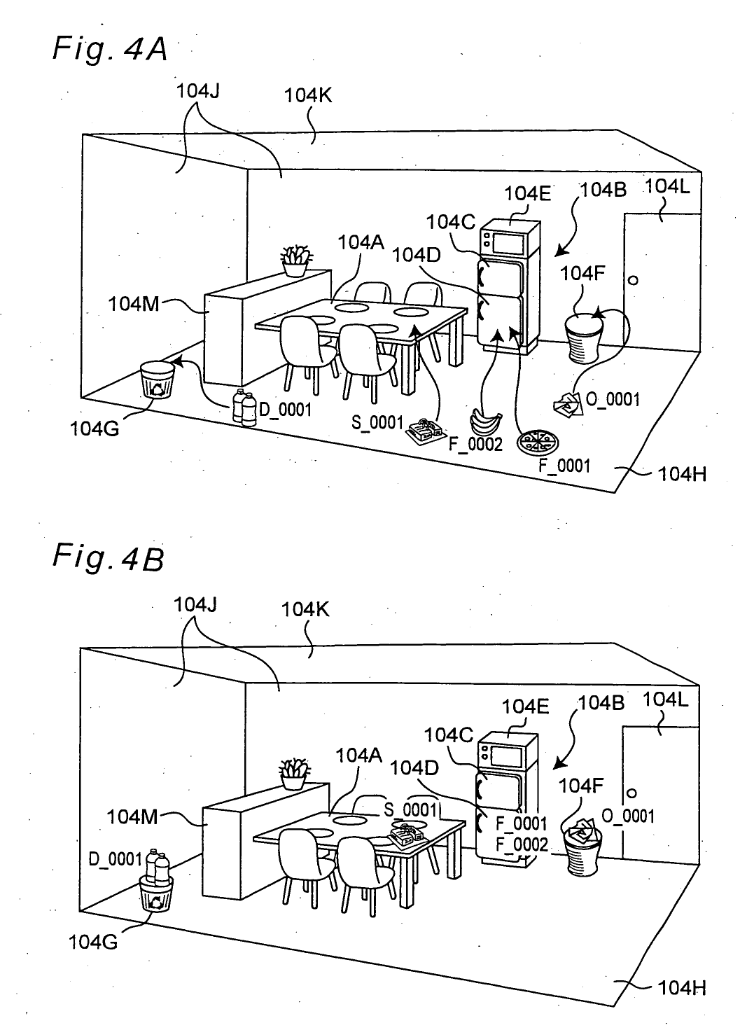

FIGS. 4A and 4B are schematic views that show states of a certain environment (for example, a room 104Z) picked up at two different times. Here, FIGS. 4A and 4B are supposed to correspond to FIGS. 3A and 3B respectively. In other words, the database in which article data existing in the room 104Z that is one example of the environment at respective times are stored, is supposed to be coincident with the database of FIG. 3A and FIG. 3B. In the respective figures, reference numeral 104A represents a table, 104B represents a refrigerator, 104C represents a freezer room, 104D represents a cold room, 104E represents a microwave oven, 104F represents a trash box, 104G represents a recycling trash box, 104H represents a floor, 104J represents each of walls, 104K represents a ceiling, 104L represents a door, and 104M represents a cupboard.

FIG. 3A shows the contents stored in the database at the time of 9:00 on October 10 in 2002 as one example. In this database, seven articles, that is, a pet bottle, a pizza, a notebook, a bunch of bananas, paper trash, ice cream, and a milk carton, are registered. Among these, as shown in FIG. 4A as the example, the five articles including the pet bottle, pizza, notebook, bunch of bananas, and paper trash are scattered on the floor 104H (for example, on the assumption that after a shopping, the articles are placed on the floor). For this reason, as shown in FIG. 3A, with respect to the values of places of the respective articles in the database, besides “floor#0001” indicating the “floor”, respective position coordinate values on the floor 104H are assigned thereto as additional information.

Of the rest of the articles, the ice cream and the milk carton are stored in the freezer room 104C and the cold room 104D (not shown in FIG. 4A), and since the places are limited to a certain degree, only “freezer#0001” corresponding to “freezer room” and “Cold_room#0001” corresponding to “cold room” are given to the figure, with respect to the values of the respective articles in the database.

Next, suppose that the following environmental changes have taken place at the time of 10:00 on October 10, in 2002:

1) With respect to the articles on the floor 104H (five articles: pet bottle, pizza, notebook, and paper trash), neatly-arranging operations are instructed by the user (respective neatly-arranging places are indicated by curved lines with arrows in FIG. 4A). In other words, the pet bottle is put into the recycling trash box 104G. The pizza and the bunch of bananas are put into the cold room 104D. The notebook is put on the table 104A. The paper trash is put into the trash box 104F. Upon receipt of the instructions, the robot 102 executes neatly-arranging operations of the articles.

2) The user has had the ice cream in the freezer room 104C and the milk in the milk carton in the cold room 104D so that the ice cream and the milk carton have disappeared.

FIG. 3B shows a state of the database at 20:00 on October 10 in 2002, after a lapse of some time from the above-mentioned environmental changes.

As shown in FIG. 4B, the five articles, the pet bottle, pizza, notebook, bunch of bananas, and paper trash, which were scattered on the floor 104H at the time of FIG. 4A, have been arranged neatly as instructed above, and the values of the places in the database have been changed accordingly (see FIG. 3B). Moreover, the ice cream and the milk carton, which have disappeared after having been eaten and drunk, are deleted from the database, and these are not shown in the database (see FIG. 3B). These deleting operations may be manually carried out, or may be automatically carried out by reading sensors such as tags by using a reader-writer. Moreover, with respect to food that is eaten by some one to disappear from the actual world, instead of describing the place thereof, a person who has eaten it may be described in the place data. Here, in the case when an instruction for arranging neatly is given and the corresponding article is put into a trash box, it is preferable to separate the article depending on its attributes so as to be discarded into different trash boxes. In order to help the separation, it is preferable to store data as to what trash each of the articles will make after having been consumed, in the article database. In FIGS. 3A and 3B, the data is stored as trash separation information.

Here, in the case when the ice cream or the milk carton has not disappeared even after consumed, for example, in the case when half of it has been consumed, the value at the original place is displayed as it is, without being deleted.

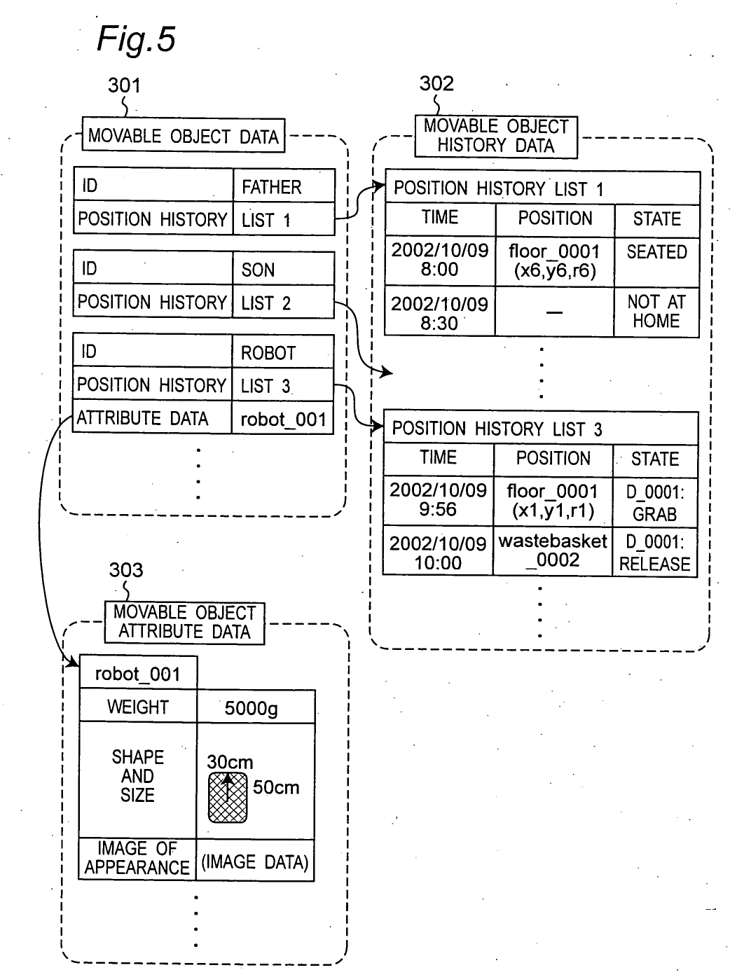

Next, referring to FIG. 5, the following description will discuss the article mobile object database 107 for dealing with the mobile object. The database for dealing with a mobile object is constituted by sub-databases for storing data of three kinds, that is, mobile object data 301, mobile object history data 302, and mobile object attribute data 303, and the respective data contents are shown below.

1) Mobile object data 301: constituted by IDs used for distinguishing individual movable objects and pointers attached to mobile object history data in which the moving histories of the mobile object are stored.

2) Mobile object history data 302: constituted by three articles including time of day, the position of the mobile object at the time of day, and the state of the mobile object at the time of day. Moreover, the position is specified by three values including coordinate values (X, Y) on the plane and the direction r.

3) Mobile object attribute data 303: used for storing inherent physical attribute information possessed by the mobile object. Here, examples thereof include weight, shape, and the like.

Here, in the mobile object history data 302, in the case when the mobile object is a man, the state of the mobile object indicates each of actions of a general man, such as “sit”, “stand”, “lie”, and “walk”, and in the case when the mobile object is the robot 102, it indicates each of actions that the robot 102 can carry out on an article, such as “grab” and “release”. With respect to these actions, feasible states are preliminarily determined for each of the movable objects, and any one of these may be applied. Here, in the case when the mobile object is the robot 102, not only the contents of operation, but also operation subject article IDs are shown in combination with the contents of operation.

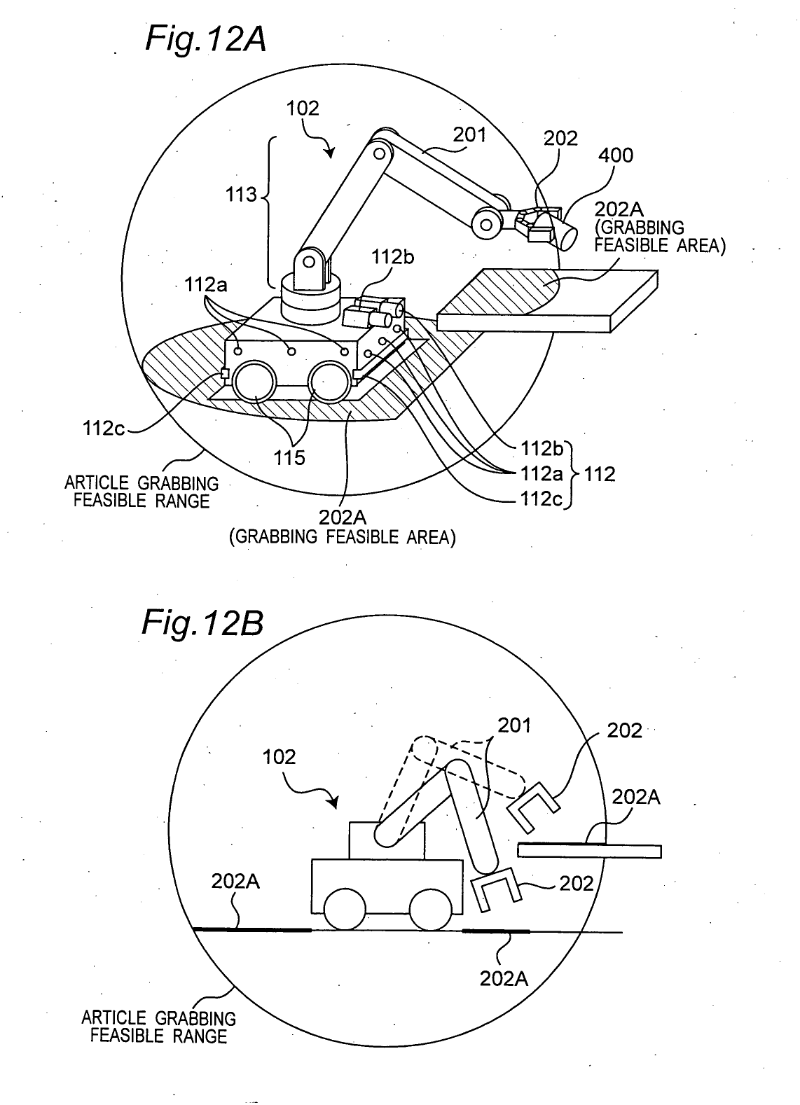

In the case when, for example, the mobile object is a working robot 102, the weight and shape of the robot 102 and the occupied space information and the like of the article grabbing unit 113 are recorded in the mobile object attribute data 303. Here, the occupied space information of the grabbing unit 113 represents information of an area occupied by the grabbing unit 113 itself (see FIG. 12A, etc.), which is required upon grabbing an article. Additionally, the occupied space information forms one portion of operation restricting information, which will be described later.

As described above, when an article or the like is moved or has disappeared from the environment, the data contents of the article mobile object database 107 are successively updated so that the latest information is always maintained in the article mobile object database 107. The above is explanation of the contents of the article mobile object database 107.

<Article Mobile object Managing Means>

The article mobile object managing means 106 carries out operations on all the articles and movable objects located inside the environment, for storing information relating to an article or the like, given from the first sensing unit 105 or by a manual input process of the user through the input device 99, in the database 107, and upon receipt of an inquiry about an article or the like from the outside of the environment managing server 101 through the first transmitter-receiver unit 110 and the first control means 111, and making the article mobile object managing means 106 taken out necessary information from the article mobile object database 107 in accordance with the contents of the inquiry to send the resulting information to the sender of the inquiry through the first control means 111 and the first transmitter-receiver unit 110. Here, only the article mobile object managing means 106 is allowed to access the article mobile object database 107, and the controlling operation is carried out so that a writing process and a reading process are not carried out simultaneously to and from the same article data. Upon receipt of a request for an information-registering/updating process of an article from the robot 102 and the operation terminal 103, the registering/updating process in the article mobile object database 107 is carried out by the article mobile object managing means 106. Moreover, by specifying a retrieving key used for narrowing down the attributes of the article to desirably know, such as the date and the kind of the article, by the use of the operation terminal 103 described later, it is possible to retrieve for the sites of the article that is looked for.

<Environment Map Information Managing Means>

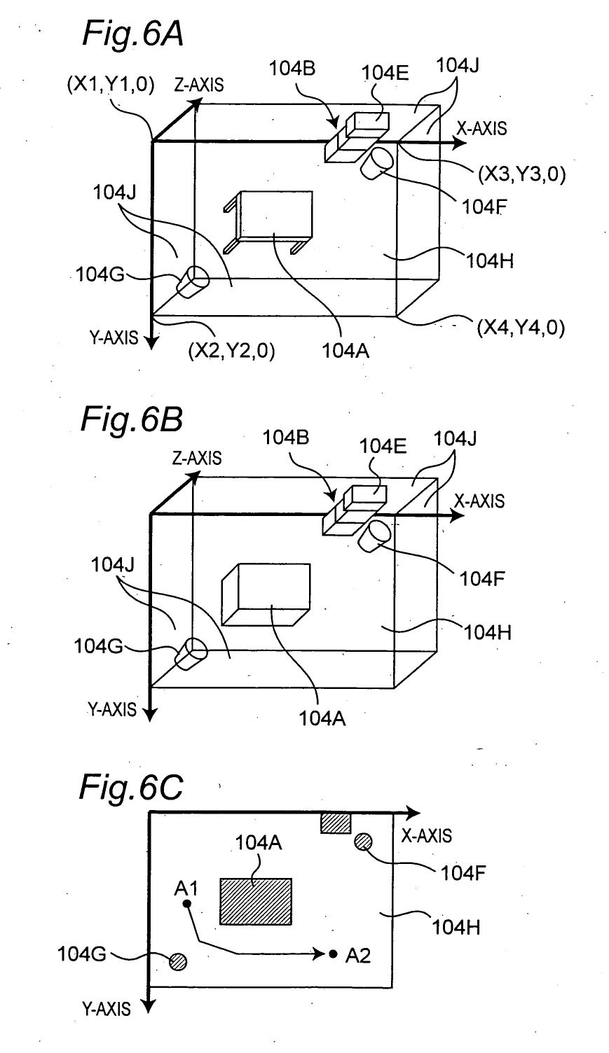

The environment map information managing means 108 carries out managing processes on the map information inside a room that is one example of the environment. FIGS. 6A to 6C are conceptual views that show examples of an environment map information database 109 in comparison with the actual situation, and FIG. 6A is a view that shows the actual situation; FIG. 6B is a view that shows the actual situation as a simplified three-dimensional model as the environment map information database 109; and FIG. 6C is a view that further simplifies the actual situation to be shown as a plane model. The environment map information database 109 may be indicated as three-dimensional data, or may be more simply indicated as plane data. The data may be formed depending on the application of the map and tasks required for forming the map; therefore, for example, with respect to a three-dimensional object, when it is necessary to form a three-dimensional model in a very short period of time, for example, it may be modeled into a minimum rectangular parallelepiped shape covering the object. FIG. 6B shows one model of such an example. In FIG. 6B, a table 104A located in the center in FIG. 6A is indicated as a model of a rectangular parallelepiped shape. With respect to the plane data, in the same manner, the table 104A located in the center in the model of FIG. 6C is orthogonally-projected onto a plane to be indicated as a rectangular area (rectangular area indicated by a hatched portion in FIG. 6C), and this area is determined as a robot movement non-permissible area. In the following description, for convenience of explanation, a position coordinates system as shown in FIGS. 6A to 6C in a world, constituted by the X-axis (direction along one side of the room floor), Y-axis (direction along the other side orthogonal to the one side of the floor of the room), and Z-axis (height direction of the room), is referred to as an actual world coordinates system.

<Environment Map Information Database>

FIG. 7 is a view that shows one example of data of the environment map information database 109. The environment map information database 109 is mainly composed of two elements, that is, environment attribute data 601 and equipment attribute data 602.

Reduced to its simplest terms, the environment attribute data 601 is detailed data of a room itself that is one example of the environment, and in the present embodiment, for example, floor face data “floor#0001” and “floor#0002” of two floors are recorded as the environment attribute data 601 (here, the second floor face data “floor#0002” is not shown). With respect to the floor face data, positional coordinate values (positional coordinate values in the actual world coordinates) of apexes (corners) are given when the floor face has a polygonal shape, and the material of each floor face is added to each of the faces. For example, in the case of the data of a floor face having a quadrangle, as shown in FIGS. 7 and 6A, the coordinate values are given as follows.
((X1, Y1, 0),
   (X2, Y2, 0),
   (X3, Y3, 0),
   (X4, Y4, 0,), 0)

Here, the height of the lowest floor in the room is set to 0, as the standard of the coordinate values. The first four coordinate values indicate coordinate values of the apexes of the floor, and the last numeric value “0” indicates the material of the floor face. With respect to the material of the floor face, for example, “0” indicates flooring, “1” indicates “tatami” floor, and “2” indicates carpet floor, and the corresponding figure is predetermined for each of the materials. In the case when there are a plurality of floor faces having different heights in a room, the floor face data as many as the number of the floors are prepared.

The equipment attribute data 602 respectively show equipments 104 located in the environment (more specifically, room) composed of the environment attribute data 601. Here, equipments 104 represent domestic articles or the like that are not moved when used in a normal state, and include, for example, furniture and large-size household electrical appliances.

In examples shown by FIGS. 6A to 6C and FIG. 7, there are equipments 104 including a table 104A, a freezer room 104C, a cold room 104D, and trash boxes 104F and 104G in a room that is one example of the environment, and the respective data of these are stored in the environment map information database 109, and their attributes are stored in the equipment attribute data 602. For example, positional coordinate values of each of the corners of respective faces 1 and 2 are stored in the table 104A as positional coordinates. Positional coordinate values of each of the corners of respective faces 1 and 2 are stored in the freezer room 104C as positional coordinates. Positional coordinate values of each of the corners of respective faces 1 and 2 are also stored in the cold room 104D as positional coordinates. Positional coordinate values of each of the corners of respective faces 1 and 2 are also stored in each of the trash boxes 104F and 104G as positional coordinates. Here, normally, the freezer room 104C and the cold room 104D are integrally formed and referred to as a refrigerator 104B; however, in the present embodiment, since the equipments are distinguished as units of places capable of housing an article or of placing an article thereon so that the refrigerator 104B is dealt not as one equipment, but as respective independent equipments, that is, the freezer room 104C and the cold room 104D.

In the equipment attribute data 602, data of a plurality of faces obtained when the surfaces of each equipment 104 are approximated as a polyhedron, the kinds of the equipments 104, and main shapes and orientations of each article that is placed on an installation feasible face of each equipment 104 are stored as attribute data of each of the equipments. With respect to the face data of the equipments, coordinate values (positional coordinate values in the actual world coordinates) of each of apexes of the face are given, and a flag indicating whether or not any article is placed on the face is given to each of the faces. For example, in the case of data of a face the number of apexes of which are four, the following coordinate values are given.
((X11, Y11, Z11),
   (X12, Y12, Z12),
   (X13, Y13, Z13),
   (X14, Y14, Z14,), 1)

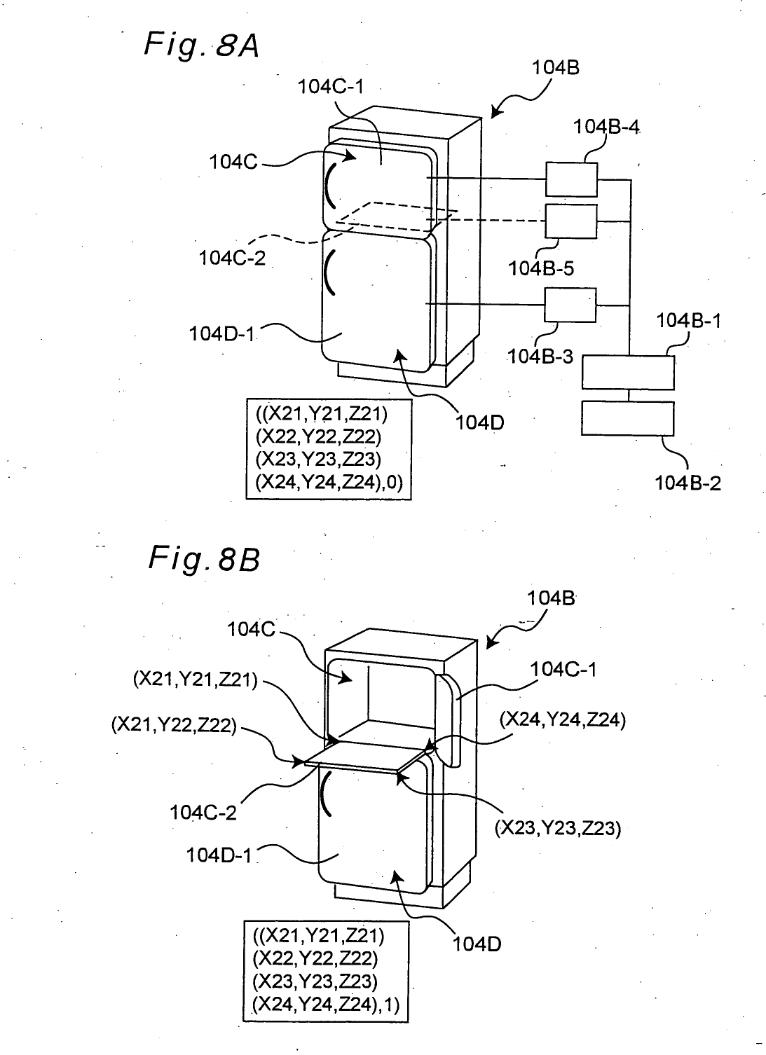

The first four coordinate values indicate positional coordinate values of the four apexes, and the last numeric value “1” is a flag indicating that the face allows an article to be placed thereon. The face having the numeric value “0” is a face that does not allow any article to be placed thereon. Depending on the types of the equipments, this flag is made switchable depending on the situations. These situations include, for example, a situation in which a face that accepts an article is exposed with the door being opened, or a situation in which the face that accepts an article is not exposed with the door being closed. FIGS. 8A and 8B are supplementary views that show such typical examples.

In the examples of FIGS. 8A and 8B, attribute data of the equipment relating to the freezer room 104C are shown. In other words, FIG. 8A shows attribute data in a state in which the door 104C-1 of the freezer room 104C is closed as follows.
((X21, Y21, Z21),
   (X22, Y22, Z22),
   (X23, Y23, Z23),
   (X24, Y24, Z24,), 0)

In contrast, FIG. 8B shows attribute data in a state in which the door 104C-1 of the freezer room 104C is opened as follows.
((X21, Y21, Z21),
   (X22, Y22, Z22),
   (X23, Y23, Z23),
   (X24, Y24, Z24,), 1)

These figures show that the last value of the flag is changed depending on the open or closed state of the door 104C-1 of the freezer room 104C. In other words, in the case when the door 104C-1 of the freezer room 104C is closed, since no article can not be stored therein in this state, the flag is set to “0”. In contrast, in the case when the door 104C-1 of the freezer room 104C is opened, since an article can be stored therein in the present state, the flag is set to “1”. Here, in the case of the freezer room 104C in FIG. 8B, mechanism may be prepared in which, in order to allow the robot 102 to take out or put an article therefrom or therein, for example, the face 104C-2 on which an article is placed may be made to protrude forward when the door 104C-1 is opened. In this case, with respect to the coordinate values of the face 104C-2 on which an article is placed, coordinate values of the four corners, (X21, Y21, Z21), (X22, Y22, Z22), (X23, Y23, Z23), (X24, Y24, Z24), which correspond to the protruded face, are given. Thus, only when the protruded face 104C-2 is maintained in the protruded state (that is, when the door 104C-1 is opened), the robot 102 takes out or puts an article therefrom or therein. The putting operation of an article on the face 104C-2 and the taking-out operation of an article placed on the face 104C-2 may be carried out while referring to the coordinate values of the face 104C-2. When the door 104C-1 is closed, the corresponding face (article placing-face) 104C-2 is housed into the freezer room 104C. Accordingly, the actual coordinate values of the face 104C-2 are changed. However, since, in the case when the door 104C-1 is closed, the robot 102 never takes out or puts an article from or in the freezer room 104C, the coordinate values stored as the equipment attribute data 602 are not changed, and left as they are.

Additionally, in the present embodiment, only the identification flag as to whether or not the placement (putting-on) of an article is available is described as the equipment attribute data 602; however, of course, another information may be added thereto on demand. For example, the material of a face may be added in the same manner as the environment attribute data 601. Moreover, the locus of the approach of a robot hand 202 to the corresponding face, which is followed when an article is placed on the face or taken out from the face, may be added thereto. Furthermore, a program used for moving the robot hand 202 may be stored and utilized. For example, a standard program specification for moving a robot arm 201 has been preliminarily determined, and when a robot 102 capable of arm-controlling in compliance with the specification is used, the program that has been stored as one portion of the equipment attribute data 602 is downloaded to the robot 102 so that the robot 102 may be moved in accordance with the downloaded program. This arrangement makes the robot 102 free from the necessity of having to prepare individual grabbing control programs for all the equipments so that it becomes possible to reduce the memory capacity for storing programs.

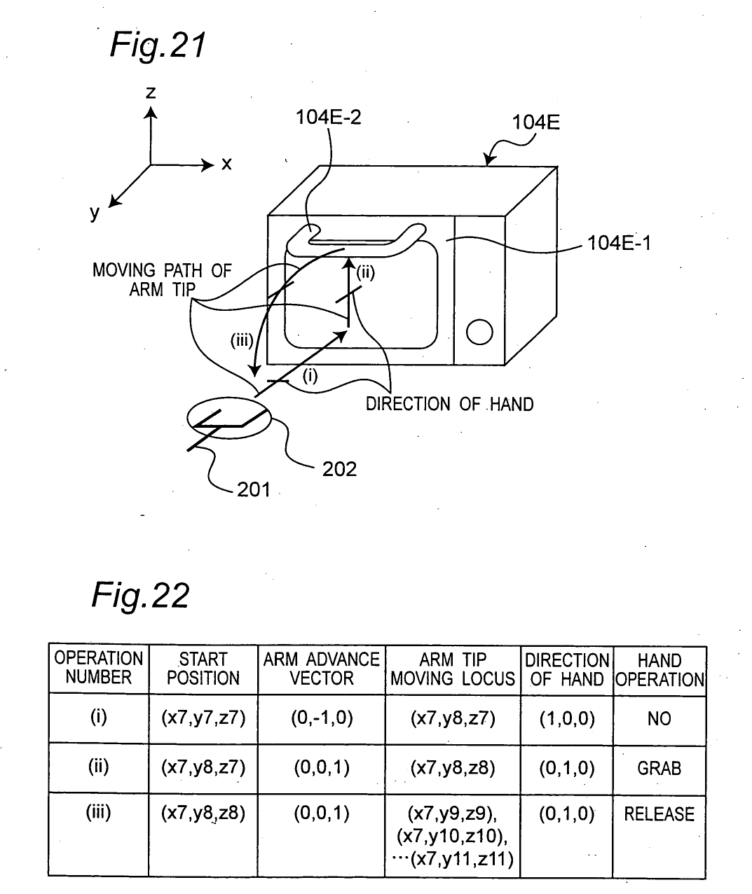

FIG. 21 is a view that explains a case in which action programs (actions for opening the door 104E-1 of the microwave oven 104E) of the robot arm 201 and the hand 202 of the robot 102 are prepared as equipment attribute data. FIG. 22 shows an example of an action program of the robot arm 201 and the hand 202 of FIG. 21. Three actions are described as actions used for opening the door 104E-1 of the microwave oven 104E serving as an equipment, and stored as one portion of the equipment attribute data 602. More specifically, the actions are composed of: (i) an action in which the arm 201 advances to the microwave oven 104E from the front side thereof and moves to a position in front of the microwave oven 104E, (ii) an action in which the hand 202 is allowed to face upward, and moved upward to the handle 104E-2 to grab the handle 104E-2, and (iii) an action in which the arm is moved to the front side with the handle 104E-2 being grabbed so that the door 104E-1 is opened. In this manner, each equipment is allowed to have actions that correspond to its inherent structure of the equipment so that general-use controlling operations of the robot 102 are maintained. Each of the actions shown in FIG. 22 is composed of the coordinates of the tip of the robot arm 201, progressing vectors of the arm 201, the locus of the movement of the tip of the arm 201 (in the case of a curved line shown in action (iii), straight-line approximated), the direction of the hand 202, and the action of the hand 202 after the movement. Here, all the coordinates in FIG. 22 are included in a coordinate system defined in the microwave oven, and the robot 102 converts these to the coordinate system of its own, based upon the position and orientation of the robot 102 and the position and orientation of the microwave oven 104E so as to execute the actions.

<Information Presentation Device>

The information presentation device 124 directly presents information to the actual environment, and is formed by utilizing, for example, a liquid crystal projector and a laser pointer, or a light source and a display that are actually installed in the actual environment. Here, “the actual environment” means an environment in which an article or a mobile object actually exists, and a virtual environment displayed on a display or the like of a computer is not included in this actual environment mentioned here. The display itself of the computer is a corporeal thing and can be a portion of the actual environment; however, the environment shown on the display does not form an actual object. “The direct presentation” of information means presenting information to the actual environment.

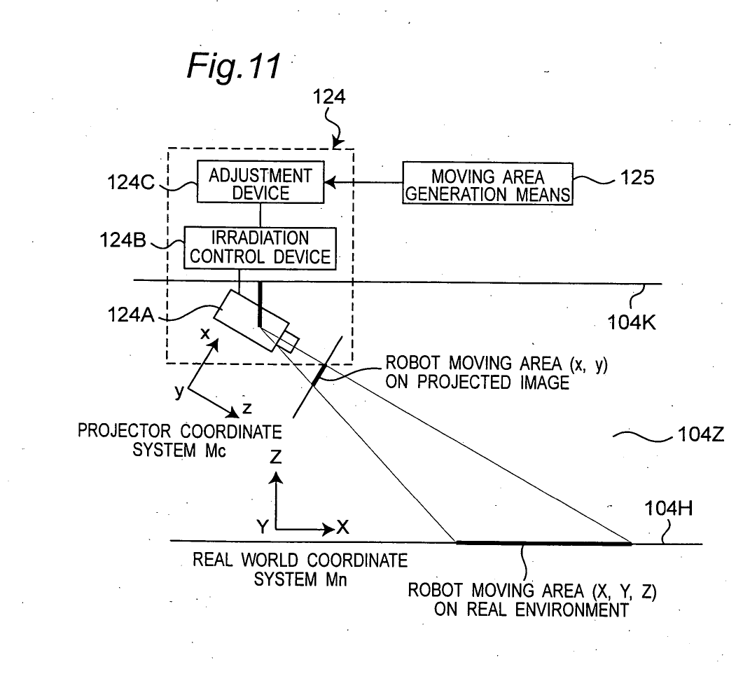

The information presentation device 124 is installed inside the room 104Z that is an example of the environment, and preferably has its presentation position of information freely changeable. For example, as shown in FIG. 11 and FIG. 17A, the information presentation device 124 is preferably constituted by a projector 124A that is an example of an irradiation device (or the projection device that projects at least one piece of information) that irradiates information to at least one of the walls, floor, ceiling, equipments, and articles (to a floor 104H in FIGS. 11 and 17A); an irradiation control device (or a projection control device that controls projection by the projector 124A) 142B that controls irradiation by the projector 124A; and an adjusting device 124C which has a panning function (a method for irradiating by slowly swinging the irradiation device (or the projection device) or the like laterally or longitudinally) and a tilting function (a tilting operation of the irradiation posture of the irradiation device (or a tilting operation of the projection posture of the projection device) of the projector 124A, or a function or a mechanism for moving or the like of the irradiation device (or the projection device). With this arrangement, the tilting and moving of the projection posture of the projector 124A are adjusted by the adjusting device 124C so that the path information and the moving occupancy area of the robot 102 serving an example of the mobile object that are projected by the projector 124A serving as an example of the projector device based upon the moving path information are made coincident with the moving path and the moving occupancy area through which the robot 102 actually moves; thus, an image pattern to be projected base upon the moving path information can be obtained. Moreover, in FIG. 1, the information presentation device 124 is placed inside the environment (for example, on a wall or a ceiling of a house); however, as indicated by an alternate long and short dash line in FIG. 1, the information presentation device 124 may be installed in the robot 102. In any case, the information presentation device 124 is adapted to confirm the position, posture, optical information (focal length, etc.), and the like at that time, and execute a predetermined presentation based upon these factors. Here, in the case when the information presentation device 124 is installed in the robot 102, this arrangement is more preferable since it becomes possible to present information even to such a place as not to be presentable (for example, a place under a desk, or the ceiling) in the case of the installation of the device on the ceiling or the like.

Data that form a source of information to be presented by the information presentation device 124 are generated by using a mobile object area generation means 125, a living assistance feasible area generation means 126, and a guide information generation means 127, which will be described below.

<Moving Area Generation Means>

The moving area generation means 125 generates area data used for moving the robot 102, prior to the moving action of the robot 102 or in the middle of the movement.

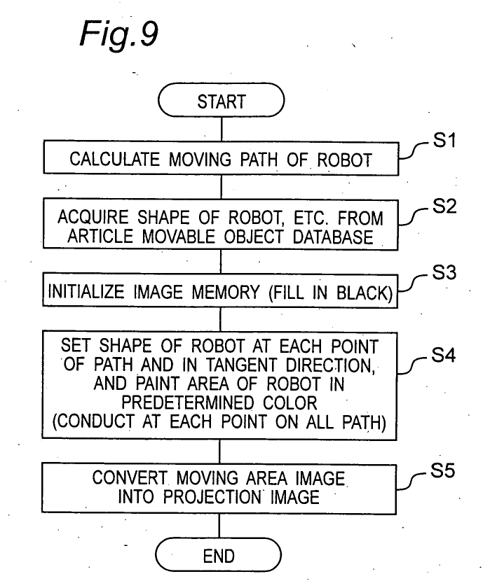

FIG. 9 is a flow chart that shows the operation of the moving area generation means 125.

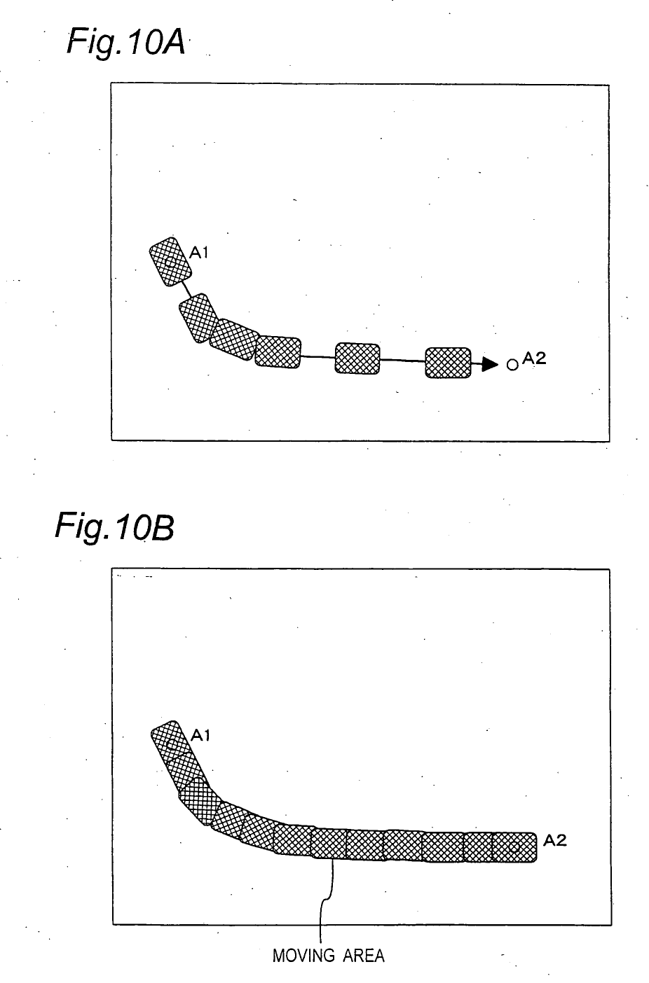

First, at step S1, the robot 102 allows a moving plan forming means 114 to calculate a path to a certain point as will be described later. For example, in FIG. 10A, the path from the point A1 to the point A2 is calculated.

Next, at step S2, information relating to the shape and the size of the robot 102 is obtained by reference to the article mobile object database 107. Based upon this path and the information of the robot 102, the area occupied by the robot 102 when the robot 102 moves in the actual environment can be calculated.

More specifically, first, at step S3, an image having a size formed by equally reducing the longitudinal and the lateral lengths of an environment map (see FIG. 6C) as shown in FIG. 10A is prepared, and this is initialized by using black pixels. The reason for initializing by the black pixels is because, upon projecting the generated image into the environment, nothing is presented in a non-related area (an area other than the moving occupancy area occupied by the mobile object upon movement of the mobile object).

Next, at step S4, the area, which is occupied when the shape (including the size information) of the robot 102 is placed along the path found by using the moving plan forming means 114 (path indicated by a solid arrow from A1 to A2 of FIG. 10A), is painted in a predetermined color (indicated by a crosshatched area in FIG. 10A). As a result, a moving area image (see a crosshatched area in FIG. 10B) indicating the occupied area for the movement of the robot 102 can be obtained.

However, even when this moving area image is projected into the actual environment by a projector or the like that is the above-mentioned information presentation device 124, the direction of the projector 124A or the like is not necessarily set perpendicularly to the floor face 104H with the result that the moving area image, projected to the actual environment, is sometimes different from the area through which the robot 102 actually moves, unless any adjustment is made. Therefore, by preliminarily taking into consideration the position and the posture of the projector 124A based upon the environment map information (in which the position and posture information of the projector 124A have been determined with respect to the projection face such as a floor face), it is necessary to generate such an image (projection image) as to be consequently projected as indicated by FIG. 10B. Therefore, at step S5, the projection image is reversely calculated based upon the moving area image, the position, posture, and optical information of the projector 124A etc., and the like.

FIG. 11 is a view that explains a method for generating a projection image. Here, the point Mn=(X, Y, Z) of the area through which the robot 102 moves in the actual environment corresponds to u=(x, y) on the projected image. This corresponding relationship can be calculated by the following equation based upon the position (x, y, z), posture, and optical information (focal distance, lens distortion information, etc., of the projector 124A and the like.
Mc=RMn+t
su=PMc

Here, R represents a rotation matrix indicating the rotation of the projector 124A or the like in the actual world coordinates, and t represents a position (translation vector) of the projector 124A etc. in the actual world coordinates so that the position Mn in the actual world coordinate system is converted to the coordinate system Mc of the projector 124A based upon the above-mentioned equations. Moreover, this is converted to a point u of an image by using a projection matrix P. Here, s represents scalar. Here, known techniques can be used for these conversions, and for example, techniques described in “Computer Vision-Technical Criticism and Future View” (edited by Matsuyama, et al. New Technical Communications) may be used. Moreover, with respect to the technique for projecting information to the actual environment, techniques described in “Automatic Acquisition of Actual Environment Model for the purpose of Information Projection to Room Space”, FIT2002 Information Scientific Technology Forum, Information Technical Letters, Vol. 1, pp. 129-130, September 2002 can be used.

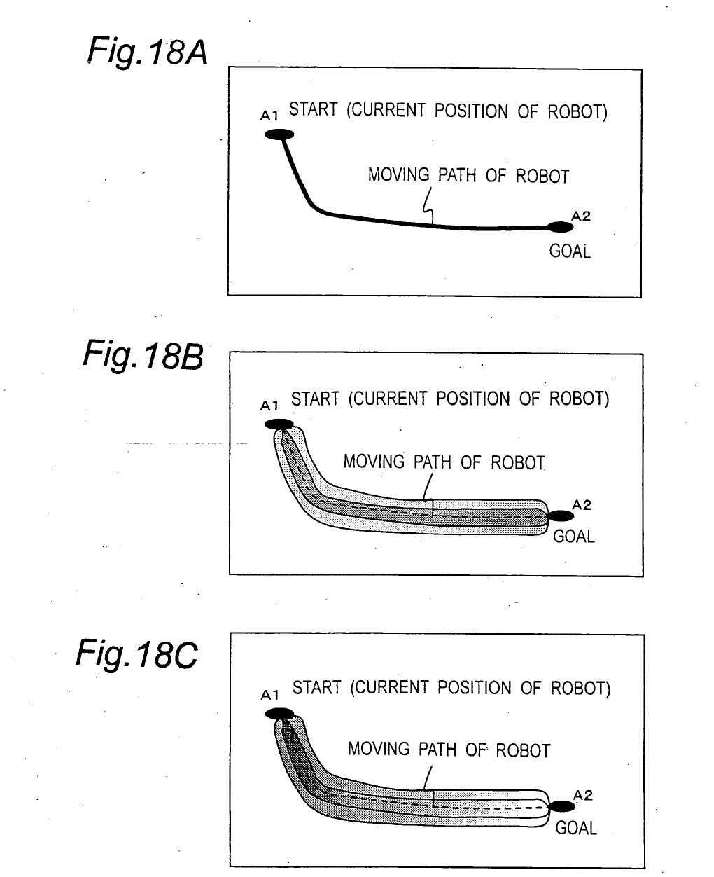

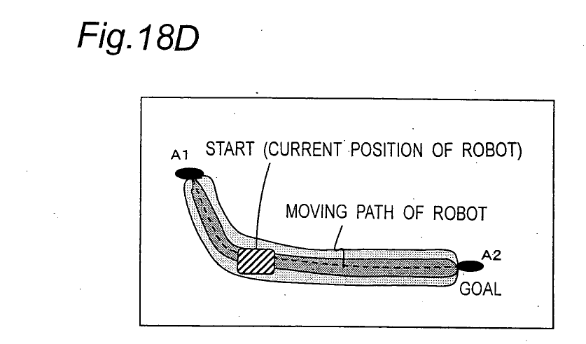

By carrying out these operations on all the points (or outline points within a moving area) within the moving area of the robot 102 on the actual environment, a projection image can be generated. Here, in this case, the arrangement is made so as to present an occupied area by the robot 102 along the path; however, in addition to this method, other presentation methods may be used in which: the path of the robot can be presented by a solid line or a dot line (see FIG. 18A), and the presentation may be made so as to gradually change the color as the robot goes away from the path (for example, even when the same red color is used, the saturation becomes smaller) (see FIG. 18B). In addition to these, an arrangement in which the color of projected light is changed depending on the speed at which the robot 102 moves or the time of arrival to each of points may be used effectively (see FIG. 18C). When any object such as a piece of furniture, which blocks the projected light, is located between the projector and the projection face, the projection process may be preferably carried out so that the pixels of the projected image, blocked by the furniture, are converted to “black” based upon the information of the environment map. Moreover, as the robot actually advances, it is preferable to stop projection to the area that the robot has already passed by. FIG. 18D is an image that is projected to the actual environment at the time when the robot 102 has moved halfway. This image is available since the position of the robot 102 is also always controlled. With this arrangement, it is possible to present not only a direction in which the robot 102 is moving now, but also a path to be taken in the future, or an area to be occupied, or areas in which the degree of hazard is shown, to the actual environment; thus, a man who is within the same environment is allowed to know a future action (will) of the robot 102 so that it is possible to preliminarily avoid anxieties and also to prevent interference with the robot 102 to get hurt.

<Living Assistance Feasible Area Generation Means>

When the robot 102 gives living assistance to a man, the living assistance feasible area generation means 126 is used for finding an area commonly shared by a man through their interactions and for generating an image for projecting the living assistance feasible area to the actual environment by the information presentation device 124. For example, when the robot 102 tries to grab and carry an article, the robot 102 can not necessarily grab any article put anywhere, and is only allowed to grab an article within the reach of the grabbing unit 113 of the robot 102. Moreover, when a man hands an article to the robot 102, the man may directly hand the article to the robot 102; however, in some cases, it is better for the man to once place an article at a position that allows the robot 102 to grab the article so that the robot 102 then grabs the article. In such cases, when the robot 102 wants the man to place the article at a position that allows the robot 102 to grab the article, it preferably displays the positional range (grabbing feasible area) in the actual environment by using the information presentation device 124 as the means to express its will. The following description will discuss the grabbing feasible area as a specific example of the living assistance feasible area.

First, a method for finding the grabbing feasible area will be explained. In general, the grabbing unit of a mobile object has an article grabbing feasible range in accordance with the position and orientation at which the mobile object is placed. FIGS. 12A and 12B show a space in which the hand 202 of the robot 102 that is one example of the mobile object can move as an article grabbing feasible range. Of course, the hand 202 cannot move to the space in which the robot 102 itself is located, and the article grabbing feasible range of course differs depending on the arrangement of the robot 102. In this case, horizontal faces, such as an equipment (table, etc.) 104 and a floor 104H, that are included within the article grabbing feasible area form the grabbing feasible area 202A (indicated by a shaded area in FIG. 12A as well as by a solid black area in FIG. 12B). Here, information of the horizontal faces such as an equipment (table, etc.) 104 and the floor 104H can be found from the environment map information database 109. Once the grabbing feasible area 202A has been found, an image corresponding to this area to be projected by the information presentation device 124 can be found by the method explained in the description of the moving area generation means 125. Here, in the case when the position of a man is also successively monitored, a position that minimizes the movement amount of the man is found within the grabbing feasible area 202A of the robot 102, and it is preferable to present such a position so as to reduce the movement of the man as small as possible. Moreover, on the assumption that the robot 102 has reached a position near the man at which man can move, the grabbing feasible area may be presented at that time; thus, it is only necessary for the man to place the article at the area, and the robot can come to pick it up so that the movement of the man can be further reduced.

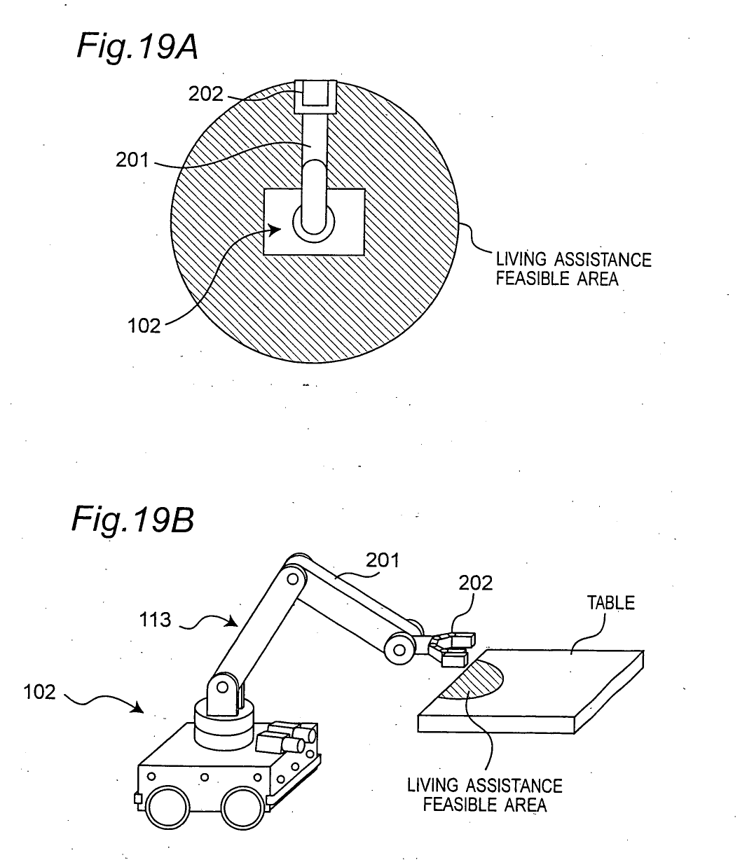

The above description has explained the grabbing feasible area as an example of the living assistance feasible area; however, an area which is to be occupied by the robot 102 when the robot 102 operates the movable portion such as the grabbing unit 113 may be presented as the living assistance feasible area so as to draw attention of the man so that it becomes possible to preliminarily prevent the grabbing unit 113 from hurting the man (see FIG. 19A). In addition, in the case when the robot 102 carries a heavy object such as a piece of furniture with a human, by presenting a portion of the furniture to be grabbed by the robot 102 as the living assistance feasible area, it becomes possible to preliminarily prevent the grabbing unit 113 of the robot 102 from pinching his/her hand (see FIG. 19B). Moreover, by presenting an area in which the robot 102 can move as the living assistance feasible area, a man is allowed to go to a place before the robot 102 reaches the place and waits for the robot 102.

<Guide Information Generation Means>

The guide information generation means 127, which, in search for an article or the like, is used for presenting a position of the article to the actual environment through the information presentation device 124 so as to let the user know the position. With respect to the method for letting the user know the position, a method in which a predetermined mark is projected to the position of a target object by using a projector or a laser pointer may be simply used. However, such a method may give more time for the user to find the mark when the article is located behind the user.

For this reason, in this method, the attention (eyes) of the user is guided so as to easily find the position of the article. More specifically, a guide path for guiding the user from the position of the user to the position of the article is found, and in the same method as used in the moving area generation means 125, an image for projecting the guide path onto the actual environment is found as guide information. Here, different from the moving area generation means 125, the information relating to the shape and the size of the robot 102 is not required.

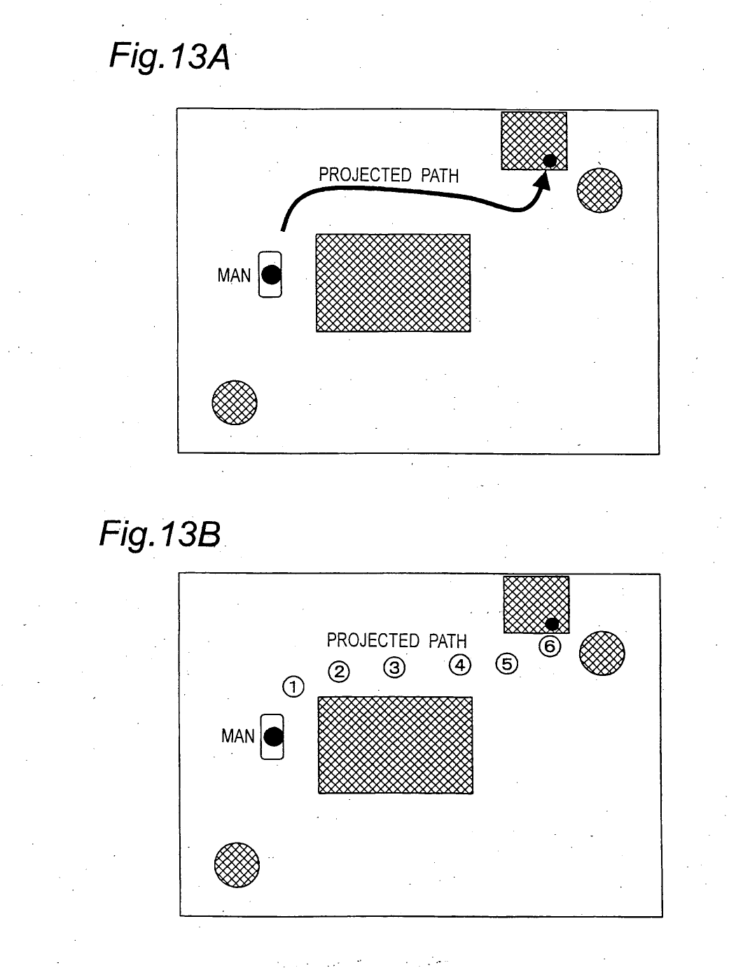

The guide information is a still image or a moving image that shows a path from the position of the user to the position of the article. FIG. 13A shows a state in which a still image is projected to the room.

In the case of projection of a moving image, a pattern which is placed along the path and changes with time may be projected to the room. For example, a circle having an appropriate size is projected and the circle may be moved from the feet of the man to the position of the article. FIG. 13B is a view that shows circles of this type, and in this figure, circles of 1 to 6 are repeatedly displayed in succession. The speed of the display is preferably set faster than the walking speed of the man. The reason is that when the speed of the display is slow, the man has to wait. More specifically, when the destination is set to another room, the same speed as the walking speed of the man is set, and when the destination is in the same room, the display speed is preferably set faster than the walking speed of the man. In the case when the destination (position of the article or the like) is located in the same room, once the destination has been visually confirmed by the man, the man can take any desired path to reach the place. Moreover, when the destination is located on the same house, the path is not necessarily given as a path on the floor through which the man walks, and another path on the wall or equipment (furniture) or the like may be calculated and displayed. This method may also be used since the main objective is accomplished by letting the man to visually confirm the destination. Here, the path can be found by using the same method as that used for finding the moving path of the robot 102. Here, in an attempt of only guiding the man's eyes, the path may be given on walls or equipments (furniture), and the shortest path (straight line) from the man's position to the position of the article may be used as the path. Moreover, since the direction of the man has been known, the guiding path is preferably found from the front side of the man.

Moreover, when the desired article is moved in the middle of the guiding process by another man or the like, the path is preferably calculated in accordance with the movement of the article so that the guide information is updated. In the present embodiment, since the position of the article has been successively detected and the corresponding position has been registered on the article mobile object database 107, the above-mentioned arrangement can be achieved comparatively easily. Upon completion of the movement of the article, the user may be guided to the position after the movement, or in the middle of the movement of the article, the man may be guided in a manner so as to follow the article. Moreover, in the case when, in the middle of the guiding, the article has been moved, the corresponding guiding operation may be suspended so as to wait for a further instruction from the user.

In the above-mentioned description, the information presentation device 124 is supposed to be installed on the environment side; however, as shown in FIG. 15, the information presentation device 124 may be installed in the robot (one example of the mobile object) 102. In this case, since the position and the orientation (direction) of the robot 102 inside the space have been monitored, the moving area, the grabbing feasible area, and the guide information of the robot 102 may be directly presented to the actual environment in the same manner as the arrangement in which the information presentation device is installed on the environment side. With this arrangement, the same effects can be obtained not only in the habitation space but also outdoors. With respect to the monitoring unit for the position and the orientation of the robot 102 outdoors, a self-position detecting technique using a GPS (Global Positioning System), such as a car navigation system, may be used.

<Environment Managing Server Control Means>

The first control means 111 of the environment managing server 101 is a unit that controls the entire system of the environment managing server 101, and as described above, the following factors are listed as the main contents of the controlling operation.

In other words, upon receipt of an inquiry concerning various data in the environment managing server 101 from the outside through the first transmitter-receiver unit 110, the first control means 111 sends a reference request for the data to the article mobile object managing means 106 or the environment map information managing means 108 in accordance with the contents thereof.

Moreover, the first control means 111 sends the results transmitted from the article mobile object managing means 106 or the environment map information managing means 108 in response to the request to the sender of the inquiry through the first transmitter-receiver unit 110.

Moreover, the first control means 111 displays the results sent from the article mobile object managing means 106 or the environment map information managing means 108 and information such as the moving area, grabbing feasible area, and guide information to the article of the robot 102 on the actual environment by using the information presentation device 124 in response to the request.

Moreover, the first control means 111 is allowed to interpret requests for registering and updating various data within the server 101 sent from the outside through the first transmitter-receiver unit 110, and sends a registering or updating request for the data to the article mobile object managing means 106 or the environment map information managing means 108 in accordance with the contents thereof.

Equipments

The equipment 104, which is the second sub-system of the living assistance system 100 of the present embodiment, is an active equipment (for example, a housing object or a placing object) having a place in which an article is housed or placed with a predetermined objective. Here, the phrase “with a predetermined objective” means, for example, “to store” in the case of a refrigerator, “to heat” in the case of a microwave oven, and the like. Moreover, the word “housing” is generally used as keeping etc.; however, in the present embodiment, the word “housing” also includes a meaning of temporarily putting an article in the place so as to achieve the objective. Therefore, for example, putting food in a refrigerator or a microwave oven is referred to as “housing”. Moreover, the word “placing” also includes a meaning of “temporarily putting-on” an article in the place so as to achieve the objective.

As shown in FIG. 1, the equipment 104 is basically constituted by: an equipment operation information storage unit 122 for receiving an operation instruction from the outside and for carrying out operations on the equipment 104; a fourth sensing unit 123 for acquiring attribute data of an article inside the equipment 104; a fourth transmitter-receiver unit 140 for receiving the operation instruction from the outside or transmitting the results of the operation to the sender of the instruction; and a fourth control means 121 for respectively controlling the fourth transmitter-receiver unit 140, the equipment operation information storage unit 122, and the fourth sensing unit 123 so that, for example, when the fourth transmitter-receiver unit 140 receives an operation instruction from the outside, the fourth control means 140 controls operations to allow the equipment 104 to carry out the corresponding operation and also allow the fourth transmitter-receiver unit 140 to transmit to the sender of the instruction the results of the operation carried out based on the operation instruction.

<Fourth Sensing Unit of Equipment>

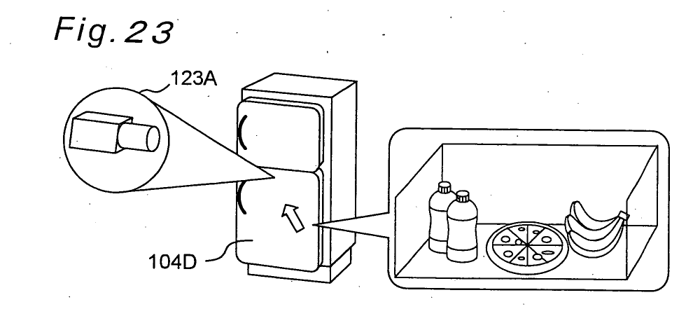

The fourth sensing unit 123 is similar to the first sensing unit 105 of the environment managing server 101. In other words, the fourth sensing unit 123 is an instrument for monitoring the state of the inside of the equipment 104, and is connected to the fourth control means 121 so as to send the monitored information and structural information of the equipment 104 to predetermined devices. The fourth sensing unit 123 always monitors the position and the state of each of subjects to be monitored, that is, articles, located within the equipment 104 to which the fourth sensing unit 123 is arranged. Moreover, in the case when a new article has been brought into the equipment 104 by a man or the robot 104, the fourth sensing unit 123 also detects the article. Here, the monitored information and the structural information of the equipment 104, are supposed to be stored in the article mobile object database 107 and the environment map information database 109 of the environment managing server 101 through the network 98. Although the specific structure of the fourth sensing unit 123 is not particularly limited, a device using an image sensor or a device using an electronic tag may be preferably utilized in the same manner as the first sensing unit 105. Moreover, for example, by forming the fourth sensing unit 123 using a camera 123A (see FIG. 23), an intuitive GUI (Graphical User Interface) using actual images inside the equipment 104 can be achieved.

<Equipment Operation Information Storage Unit>

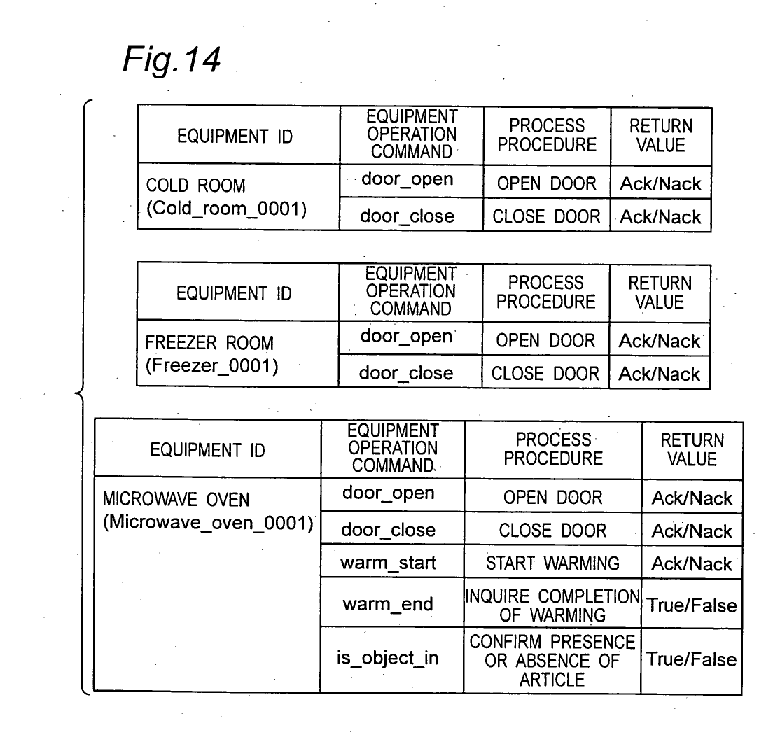

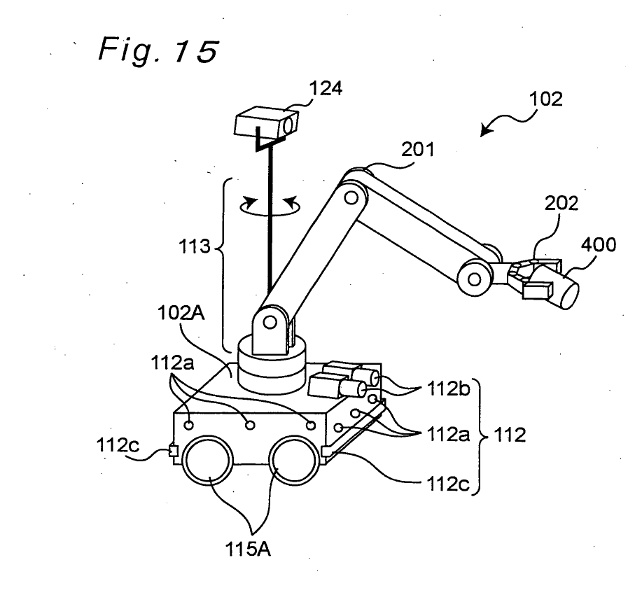

The equipment operation information storage unit 122 is mainly used for storing commands (equipment operation commands) for remote-controlling the equipment 104 from the outside. FIG. 14 is a view that shows the equipment operation commands stored in the equipment operation information storage unit 122 in a table format. Information described in the table indicates in succession from the left row equipment IDs that distinguish equipments located in the environment, equipment operation command names used for controlling the equipments from the outside, processing sequences corresponding to the commands, and returned values as the results of the processing.

Here, examples of equipments include those of three kinds, which are distinguished by equipment IDs, “Cold_room#0001” (cold room), “Freezer#0001” (freezer room) and “Microwave#oven#0001” (microwave oven), with respective operation instruction commands being attached thereto. The following description will discuss the meaning of each piece of information described by using these examples.

The cold room 104D and the freezer room 104C, which are first two examples, each have the following equipment operation commands.
“door#open”
“door#close”

When the cold room 104D and the freezer room 104C receive each of these commands from an external device (for example, from the robot 102; or an operation terminal or the like of a personal computer, a PDA (Personal Digital Assistance), or a cellular phone) with a refrigerator transmitter-receiver unit 104B-2 (functioning as one example of the fourth transmitter-receiver unit 140), the equipment itself carries out the corresponding operation, “open the door” or “close the door”, under control of the refrigerator control means 104B-1 (which functions as one example of the fourth control means 121) as shown in the processing procedures in FIG. 14. Thus, a door 104D-1 and a door 104C-1 of the cold room 104D and the freezer room 104C are automatically opened and closed independently by operation-controlling a cold room door automatic opening/closing mechanism 104B-3 and a freezer room door automatic opening/closing mechanism 104B-4 through the refrigerator control means 104B-1. Next, when the process of each of the equipment operation commands has been completed normally, “Ack” is returned to the external device that is transmitter side of the command and when the process of each of the equipment operation commands has failed, “Nack” is returned to the external device that is the transmitter side of the command, respectively as return values from the refrigerator control means 104B-1 by the refrigerator transmitter-receiver unit 104B-2. Here, when the equipment 104 is prepared as the cold room 104D or the freezer room 104C, the inside of each of these is preferably viewed in a transparent manner without opening the door; therefore, two commands, “door#transparent#on” and “door#transparent#off”, may be prepared so as to make the door switched between transparent and non-transparent states. With respect to the transparent/non-transparent switchable door, for example, a liquid crystal shutter or blind is attached to a transparent door, and such a door can be achieved by switching the transparent state and non-transparent state by the refrigerator control means 104B-1.

The microwave oven 104E, which is a third example, has the following five equipment operation commands.
“door#open”
“door#close”
“warm#start”
“warm#end”
“is#object#in”

Among these, “door#open” and “door#close” have the same operations as those of the cold room 104D and the freezer room 104C, and the description thereof is omitted.

Upon receipt of the equipment operation command “warm#start” from an external device (for example, robot 102) by a microwave oven transmitter-receiver unit (which functions as another example of the fourth transmitter-receiver unit 140), a warming process is started under control of a microwave oven control means (which functions as another example of the fourth control means 121) as shown in the processing procedures in FIG. 14. In this case, an article is put in the microwave oven, and when the warming process is started, “Ack” is returned to the external device that is transmitter of the command and in the other case, “Nack” is returned to the external device that is the transmitter of the command, respectively as return values from the microwave oven control means by the microwave oven transmitter-receiver unit. Upon receipt of the equipment operation command “warm#end” from the external device by the microwave oven transmitter-receiver unit, the microwave oven control means examines whether or not the warming process has been completed, and when the warming process has been completed, “True” is returned to the external device that is the transmitter end of the command, and when the warming process is still continued, “False” is returned to the external device, respectively by the microwave oven control means as return values with the microwave oven transmitter-receiver unit. Upon receipt of the equipment operation command “is#object#in” from the external device by the microwave oven transmitter-receiver unit, the microwave oven control means examines whether or not any article is present inside the microwave oven, and when any article is present in the microwave oven, “True” is returned to the external device that is the transmitter of the command, and when no article is present therein, “False” is returned to the external device that is the transmitter of the command, respectively by the microwave oven control means as return values by the microwave oven transmitter-receiver unit. In this case, the confirmation of the presence or absence of any article can be conducted by using an image sensor or a weight sensor, or when an electronic tag is attached to the article, an electronic tag sensor can be used for this purpose.

As described above, with respect to the equipment 104, the equipment operation commands have been briefly explained by exemplifying the three cases, that is, the cold room 104D, the freezer room 104C, and the microwave oven 104E, and required equipment operation commands can be prepared depending on functions of respective equipments 104. Moreover, when an equipment operation command is newly prepared on the producer for an equipment 104, the command may be written in the storage means of the equipment 104 by using a storing medium of a certain kind, or in the case when the equipment 104 is connected to the producer through the external network 98, the equipment operation command may be sent to the equipment 104 through the network to be stored in the storage means so that it can be used as a new operation command.

Operation Terminal

The operation terminal 103, which is the third sub-system of the living assistance system 100 is a terminal device that allows the user to give instructions on article operating processes within the environment.

As shown in FIG. 1, the operation terminal 103 is basically constituted by an article operation device 118 through which the user inputs operation instructions such as an article moving instruction for specifying an article and a transfer place of the article; a third transmitter-receiving unit 142 for sending the contents of the instruction of the article operation inputted through the article operation device 118 to the environment managing server 101; a speaker 119 for informing of the system state by voice; and a third control means 120 for controlling the article operation device 118, the third transmitter-receiver unit 142, and the speaker 119 respectively to carry out an operation control so that, for example, an article moving instruction for specifying an article and a transfer place of the article is given through the article operation device 118.

<Article Operation Device, Speaker>

With respect to the article operation device 118, an input device through which an instruction of the user is inputted by using techniques such as voice recognition, gesture (fingertip) recognition, and sight-line recognition is preferably used. The use of such an input device makes the user free from time consuming tasks, such as going to a keyboard, that are required when, for example, the user tries to input information of a thing to look for through the keyboard or the like. With respect to techniques of the voice recognition, gesture (fingertip) recognition, and sight-line recognition, known techniques can be desirably utilized.

When, for example, upon giving an instruction to look for an article, the article is not found because someone has taken it away, the speaker 119 is used for informing the user of this fact by using a speech synthesis technique.

The man-machine interface such as the article operation device 118 and the speaker 119 is preferably embedded in a wall or the like of a room so as not to allow the user to recognize the existence thereof.

Additionally, upon transferring an article, predetermined marks or the like may be projected to the position before the transfer (the position at which the article is located) and the position after the transfer by using the information presentation device 124 so that the user is allowed to recognize what the robot is going to do. With this arrangement, when the article that the robot 102 is going to grab and the article that the user wants to transfer are different from each other, or when the place to which the robot 102 tries to transfer the article and the destination position that is desired by the user are different from each other, the process can be suspended, and is easily re-operated. At this time, the projection timing of the marks may be controlled. For example, the projection timing may be controlled so that, when the robot 102 is going so as to grab an article, the mark is projected to the position at which the particle is currently located, and when the robot 102 is going to a placement position with the article, the mark is projected to the planned position of placement.

<Control Means of the Operation Terminal>

Upon receipt of such an operation instruction from the article operation device 118, the third control means 120 generates instruction data, and sends the instruction data to the second transmitter-receiver unit 141 of the robot 102 through the third transmitter-receiver unit 142 and the network 98. The instruction data forms original data based on which an action plan of the robot 102 is formed by an action plan forming means 117 of the robot 102. The instruction data has two sets of values (article to be operated, transfer position). For example, in the case when a notebook is transferred onto a table, “notebook S#0001, table” is given as instruction data. With respect to the transfer position, only those places registered in the environment attribute data 601 or the equipment attribute data 602 that have been registered in the environment map information database 109 can be specified. Moreover, in the case when, since the transfer position has a wide range to a certain extent, the place is not specified only by the name of the transfer position, the place can be specified by using coordinate values in the actual world coordinate system (a positional coordinate system shown in FIG. 6, which is a positional coordinate system indicating an actual position by reference to the environment) as specific positional coordinate values added to the transfer position. For example, this corresponds to a case in which an article is placed on a predetermined place on a floor, and the place is specified as “article, floor (x1, y1, 0)”. The positional coordinate values in the actual world coordinate system of the place specified on the display screen can be calculated by using the control means or the like through a method in which, for example, information of the three-dimensional model environment map as shown in FIG. 6B is preliminarily stored in the environment map information database 109 and calculations are made based upon the three-dimensional model and parameters (position, orientation, picture angle, etc. of a camera 105A) of the camera 105A that provides the display screen. Here, such a calculation method is a basic known technique in computer graphics; therefore, the description thereof is omitted. Moreover, when the three-dimensional model and the camera parameters have been known, the aforementioned environment map information database 109 can also be found through calculations.

Moreover, in order to simply find the position of an article, the position of the article is asked to the environment managing server 101. The results may be informed by highlight-displaying the position on the image of the actual environment displayed on the information presentation device 124, or may be more preferably displayed as guiding information to the article in the actual environment by using the guide information generation means 127 and the information presentation device 124 on the environment managing server 101. In this case, when the article is placed within the equipment 104, a command “door#open” is transmitted to the equipment 104 so that the door of the equipment 104 can be opened.

Robot

The robot 102, which is the fourth sub-system, functions in such a manner that it actually grabs an article in the environment and carries it in the living assistance system 100 of the present embodiment.

As shown in FIGS. 1 and 15, the robot 102 is basically constituted by: a sensor (for example, an obstacle sensor) 112 for detecting obstacles near the periphery of the robot 102 and obtains information of an article 400 to be grabbed; a grabbing unit 113 for grabbing the article 400; a movement plan forming means 114 for forming a movement plan (for example, generating a moving path information) of the robot 102 by using the environment map information database 109; an action plan forming means 117 for planning the action plan of the robot 102 in accordance with the contents of an instruction so as to execute an instruction from the user; a driving unit 115 for moving the robot 102; a second transmitter-receiver unit 141 for transmitting and receiving various data through the first transmitter-receiver unit 110 of the environment managing server 101, the third transmitter-receiver unit 142 of the operation terminal 103, the fourth transmitter-receiver unit 140 of the equipment 104, and the network 98; and a second control means 116 for controlling the sensor 112, the second transmitter-receiver unit 141, the grabbing unit 113, the movement plan forming means 114, the action plan forming means 117, the driving unit 115 and (the information presentation device 124) respectively to carry out operation controls on the robot 102.

With respect to the article grabbing and transferring operations of the robot 102, the user gives an instruction thereto through the operation terminal 103 (more specifically, the article operation device 118, the third control means 120, and the third transmitter-receiver unit 142), and instruction data corresponding to coded data of the contents of the instruction is transmitted to the second transmitter-receiver unit 141 of the robot 102 through the network 98. When the second transmitter-receiver unit 141 of the robot 102 receives the instruction data, the action plan forming means 117 forms a list of robot controlling commands based on which the robot 102 takes actions from the instruction data under control of the second control means 116 so that the second control means 116 of the robot 102 processes the robot controlling commands in succession to execute the grabbing and transferring operations of the article 400.

Here, the robot controlling commands refer to commands used for controlling the equipment 104 related to the grabbing by the robot 102, the movement of the robot 102, and the actions of the robot 102, and are mainly classified into the following four kinds of operations.
move
grab
release
equipment operation

The following description will discuss these operations.

Here, the “move” is indicated by “move, coordinate values” or “move, equipment ID”. Upon receipt of this command, the robot 102 moves from the current position to the position specified by the coordinate values or the equipment 104 specified by the equipment ID. Here, the coordinate values are specified in the actual world coordinate system, and the moving path is planned by the movement plan forming means 114. Upon moving to the equipment 104, the movement plan forming means 114 forms a path to allow the robot 102 to come close to the equipment 104 with a predetermined distance. Here, the coordinate values of the equipment 104 can be obtained by reference to the equipment attribute data 602 in the environment map information database 109 through the network 98.

The “grab” is indicated by “grab, article ID”. Upon receipt of this command, the robot 102 grabs the article 400 specified by the article ID. The place of the article 400 is confirmed by reference to the article mobile object database 107 through the network 98, and after a grabbing plan has been formed as one example of the action plan by the action plan forming means 117, the grabbing unit 113 executes the grabbing plan based upon the grabbing plan thus formed so that the article 400 is grabbed.

The “release” is indicated by “release”. Upon receipt of this command, the robot 102 releases the hand 202 forming the grabbing unit 113 so as to release the article 400 that has been grabbed by the hand 202.

The “equipment operation” is indicated by “robot ID, equipment ID, equipment operation command”. Upon receipt of this command, the robot 102 sends a specified equipment operation command to the equipment 104 specified by the equipment ID through the network 98. The equipment operation command refers to an operation instruction command received by each of individual equipments 104 from the external device, and upon receipt of the operation instruction command through the network 98, each equipment 104 carries out a process corresponding to the operation instruction command under control of the respective control means. Here, the reason for adding its own ID to the operation instruction command is because, in the case of sending an operation instruction command to a certain equipment 104, after the received equipment 104 has executed the operation corresponding to the operation instruction command, this arrangement allows the equipment 104 to return the results of the operation to the robot 102 itself through the network 98. Based upon the contents of the return information, the robot 102 can confirm whether or not the equipment 104 has executed the process in accordance with the operation instruction command.

As described above, four kinds of robot controlling commands have been explained as typical examples. However, not limited to these four kinds, the robot controlling commands may of course be increased or decreased on demand.

FIG. 15 is a schematic view that shows one example of the robot 102. In the following description, on the assumption that the direction in which the tip of the arm 102 is directed is the front side of the robot 102 in FIG. 15, the respective means or units of the robot 102 will be explained.

<Driving Unit>

The driving unit 115 is formed by the total number of four wheels 115A on the two sides, two of which are respectively installed on each of the sides of a robot main body 102A, and a driving device such as a motor for driving the four wheels or at least two wheels 115A. In the present embodiment, a driving device for wheels has been exemplified as the driving unit 115; however, as the driving unit 115, a best-suited device or mechanism may be selected depending on the place and environment at which the robot 102 is used. For example, when used so as to move on the ground with many irregularities, a crawler type or multi-leg walk type driving unit may be used. Here, in the case when a grabbing unit 113 constituted by an arm 201 and a hand 202 has a movable range that covers the entire house including a room that is one example of the environment, this driving unit 115 is not necessarily required.

<Sensor>

The sensor 112 is used for detecting obstacles or the like near the periphery of the robot 102, and in the present embodiment, is constituted by: ultrasonic sensors 112a; a stereo camera 112b that functions as one example of a visual sensor, and is placed on the front face of the robot main body 102A; and collision sensors 112c that are placed on the front face and the rear face of the robot main body 102A. Three of the ultrasonic sensors 112a are attached to each of the front face, the rear face, and the right and left side faces of the robot main body 102A so that by measuring time required for ultrasonic waves from their emission to the receipt of reflected waves, an approximate distance from the ultrasonic sensor 112a to an obstacle is measured. In the present embodiment, a short-distance obstacle can be detected by the ultrasonic sensors 112a before collision. The stereo camera 112b inputs the peripheral state as an image, and the image is subjected to treatments such as recognition by the second control means 116 so that determination as to the presence of any obstacle and more accurate information of the article as a grabbing subject can be obtained by the second control means 116. The collision sensor 112c is a sensor used for detecting any impact with a predetermined force imposed on the sensor 112c, and with respect to obstacles that cannot be detected by the other sensors, the collision thereof from the outside and the collision of the robot 102 thereto during the movement can be detected by the collision sensor 112c.

<Movement Plan Forming Means>

Upon receipt of a robot controlling command for moving the robot 102 to a specified place, the movement plan forming means 114 forms a moving path from the current position to the specified place by using the environment map information database 109 acquired from the environment managing server 101 through the network 98. As a matter of course, when there is an obstacle between the current position to the destination, it is necessary to prepare a path to avoid this, and as described earlier, since the movable area of the robot 102 has been preliminarily recorded in the environment map information database 109, the movement plan forming means 114 can form the moving path within the area. In the case when, after the moving path has been once formed by the movement plan forming means 114, the robot 102 has started moving under the control of the second control means 116, and the sensor then detects any obstacle, the movement plan forming means 114 again forms a new path so as to avoid the obstacle each time such an obstacle appears. Upon forming the moving path, a Dijkstra method, which is the most common technique, can be used.

<Information Presentation Device>

As shown in FIGS. 11 and 17A, the information presentation device 124 is normally installed on the environment side; however, as shown in FIGS. 15 and 17B, the information presentation device 124 may be installed on the robot 102 so that the moving path of the robot 102 and the movement occupancy area as well as the living assistance feasible area can be presented. When an image pattern is projected onto a floor face, furniture, or the like from the information presentation device 124 installed in the robot 102 also, the same processes as those shown in FIG. 11 can be carried out. The position and the orientation of the robot 102 inside the environment are controlled by the environment managing server 101, and since the robot 102 controls the information presentation device 124 so that the position and the orientation can be obtained. Therefore, the position and the orientation of the information presentation device 124 installed in the robot 102 within the environment can be converted to absolute coordinates within the environment so that they are treated in the same manner as those of the information presentation device 124 installed inside the environment.

Here, in FIG. 15, the information presentation device 124 is attached in an independent manner from the rotary shaft of the grabbing unit 113, and allowed to rotate independently from the grabbing unit 1113.

FIG. 17B is a view which shows a movable area of the robot 102 presented by using the information presentation device 124 installed in the robot 102. In the same manner, it can of course present a living assistance feasible area.

<Grabbing Unit>

The grabbing unit 113 is a device or a mechanism used for grabbing an article, and in the present embodiment, is constituted by an arm 201 with multiple joints as shown in FIG. 15, and a hand 202 attached to the tip of the arm 201. Upon receipt of a robot controlling command, which will be described later, to instruct a grabbing position, the grabbing unit 113 moves the tip of the arm 201 to the place so that a grabbing operation is conducted by the hand 202. The arm controlling operation for moving the hand 202 to the grabbing position can be carried out by the grabbing unit 113. When instructed to release by a robot controlling command, the grabbing unit 113 also carries out a releasing operation on the hand 202.

<Robot Second Control Means>

The second control means 116 interprets a list of robot controlling commands sent from an external device through the network 98 and the second transmitter-receiver unit 141, and executes the robot controlling commands in succession. When the robot controlling commands thus sent are given as the instruction data, the contents thereof are sent to the action plan forming means 117 so as to convert the instruction data to executable robot controlling commands for the robot 102, and the results of the operations are received so that the robot controlling commands are executed in succession.

<Action Plan Forming Means>

The action plan forming means 117 is a means prepared so as to allow the user to give an operation instruction to the robot 102 by carrying out a simple operation, such as specifying an article so as to transfer the article to a predetermined position, through the article operation device 118 in the operation terminal 103. More specifically, when the robot 102 has received instruction data from the operation terminal 103 through the network 98, the action plan forming means 117 forms a list of robot controlling commands so as to allow the robot 102 to execute a sequence of operations based upon the instruction data, while referring to the robot controlling command DB (database) 90 connected to the second control means 116, if necessary.

Here, the robot controlling command DB 90 is allowed to preliminarily store a list of robot controlling commands to be used when the robot 102 carries out equipment operations, in a separate manner for the respective equipments. The reason for this is explained as follows.

As described earlier, the instruction data contains only two pieces of data information, that is, “an article to be operated, destination position”. If the target article is in such a state as to be grabbed, as it is, in front of the robot 102, or if the transfer place is an open place in terms of space, the robot controlling command DB 90 is not particularly required. In an actual state, however, the target article is hardly located in front of the robot 102, and, normally, the robot 102 (or the grabbing unit 113) needs to move close to the article to be operated. Moreover, in the case when the article is placed inside a closed equipment with a door, the door needs to be opened to grab the article, and the door needs to be then closed. Moreover, depending on the equipments 104, after the article has been housed or placed, more complicated processes are sometimes required. In the case when the user needs to successively instruct these processes one by one through the operation screen, it is not possible to provide a system that is easily used. If possible, it is preferable to properly give instructions to the robot 102 by using simple instruction operations only required for generating the aforementioned instruction data, that is, by mainly using only two operations, that is, selecting an article and instructing a housing or placing place (transfer place).

Therefore, knowledge data, used for forming robot controlling commands to allow the robot 102 to execute predetermined operations, including operations for the equipment 104, from the instruction data generated by a simple instruction operation, is required. The robot controlling command data DB 90 is formed by storing the knowledge data.

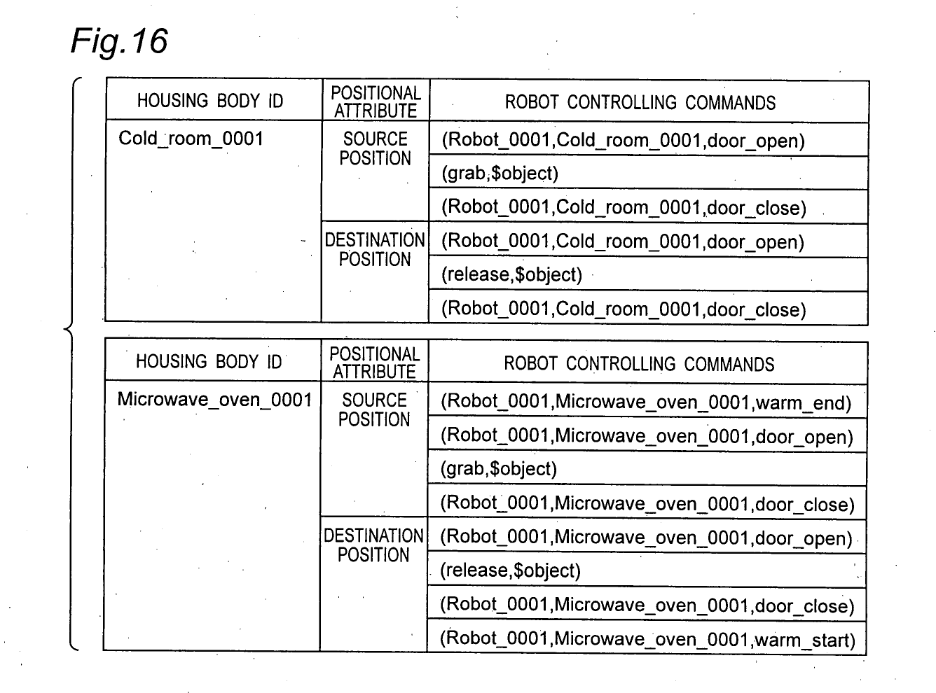

FIG. 16 is a view in a table format that shows an example of a list of robot controlling commands stored in the robot controlling command DB 90. In this figure, tables for two different equipments (refrigerator and microwave oven). The first left column of each table indicates IDs of equipments to be operated by the robot 102. The column on the right side of this, “positional attribute”, indicates “source position” and “destination position”, which respectively have the following means.

Source position: in a state where an article is housed or placed in an equipment 104, and an attempt is made to take the article out, and

Destination position: house or place an article in a certain equipment 104, and an attempt is made to execute any process on the article housed or placed by using various functions of the equipment on demand. The first right column indicates a list of robot controlling commands corresponding to attributes to the place.

For example, the list of robot controlling commands in which the equipment ID is “Cold_room#0001” (cold room), and the attribute to the place is given as the source position is explained. This corresponds to a list of robot controlling commands that are obtained as a result of reference to the article mobile object database 107 in search for an article put as the first value of instruction data when the article is housed in “Cold_room#0001” (cold room). Here, the three commands successively correspond to the following operations.

Open the door of “Cold_room#0001” (cold room),

Grab the article and take the article out, and

Close the door of “Cold_room#0001” (cold room).

Here, “$object” in the second robot controlling command “grab, $object” means that an ID of an article to be operated should be inputted therein. With respect to information whose value varies depending on circumstances, such information is dealt as a variable by putting $ to its leading portion, and when the article to be dealt is determined specifically by the instruction data, the corresponding value is set to the variable. With this arrangement, the robot controlling command is used more commonly.

In this case, in order to make the contents of the robot controlling command easily understood, an explanation has been given by using very simple examples; however, in practical use, more robot controlling commands required may be added. For example, a command list for the destination position of the microwave oven is composed of the following four commands.

“Robot#0001, Microwave#oven#0001, door#open”

“release, $object”

“Robot#0001, Microwave#oven#0001, door#close”

“Robot#0001, Microwave#oven#0001, warm#start”

In actual cases, however, since no more article can be put when any article has already been put in the microwave oven, the following command used for confirming whether or not any article is present in the microwave oven is preferably set prior to these four commands as follows.

“Robot#0001, Microwave#oven#0001, is#object#in”

In the case when the return value for this command is “TRUE”, that is, in the case when any article is present in the microwave oven, instead of executing the successive commands, the user may be informed of the fact that the microwave oven has included any article, and the sequence may be ended.

When this command string is applied to any article to be put into the microwave oven, an issue arises in which the “warming” process is carried out on any article. For this reason, for example, an arrangement may be prepared in the microwave oven so that the contents of an article are recognized and a specific way of warming in the “warming” process can be switched. For example, when the microwave oven has “warming food” and “defrosting” functions as specific functions for “warming”, the article put in the microwave oven is recognized by a certain method, for example, an image process and an electronic tag attached to the article recognized by using a reader-writer attached to the microwave oven or in the vicinity thereof, and in accordance with the results, the above-mentioned “warming food” and “defrosting” functions may be appropriately switched. Of course, this switching process may be executed by using another method. For example, in the case when the microwave oven does not have the recognizing function, the robot 102 is allowed to have such a function so that, after having recognized the contents of the article, the robot 102 may send the results thereof to the microwave oven.

As described above, in the present embodiment, the action plan forming means 117 generates and executes a series of lists of the robot controlling commands to realize instruction data by using such robot controlling command DB 90.

Prior to executing the list of robot controlling command list, a moving path of the robot 102 is transmitted to the environment managing server 101 so that the moving area of the robot 102 is displayed on the actual environment by using the moving area generation means 125 and the information presentation device 124; thus, it becomes possible to prevent collision between the robot 102 and the user. FIG. 17A is an example in which the moving area of the robot 102 is displayed on the actual environment in this manner. In this example, the moving area is projected by the projector 124A attached to a ceiling; however, the moving area may be displayed on the floor serving as a display. Moreover, a display may be effectively installed not only on a floor and a wall in the room, but also on the equipment or the article. For example, a camera may be installed in the refrigerator, and the video image may be displayed on the door of the refrigerator, or a video image of food may be displayed on a display attached to a dish. With this arrangement, it becomes possible to confirm the food storage without using a special terminal and without opening the refrigerator, while saving electric power, or by successively displaying the past menu of dishes by reference to the history (images) of the past menu, it becomes possible to effectively select the menu of the day.

As described above, the present living assistance system 100 of FIG. 1 is constituted by the four sub-systems, that is, the environment managing server 101, the robot 102, the equipment 104, and the operation terminal 103. These sub-systems are arranged to exchange information from each other through the network 98, such as a radio or wired network. In this case, the operation terminal 103 may be attached to the environment managing server 101, the equipment 104, or the robot 102, or may be attached to a plurality of portions thereof. Alternatively, not only one robot 102, but also a plurality robots may be used and these may execute operations cooperatively in parallel with one another. For convenience of explanation, FIG. 1 shows only one equipment 104; however, in the case of a plurality of equipments, the respective equipments 104 are incorporated into the living assistance system 100.

The above description has explained an arrangement in which only one operation, that is, a certain article is transferred from one place to another place, is instructed by the user so that the operation is executed. In actual cases, however, the user wants to give two or more instructions. In these cases, when an arrangement is made so that after a process for one instruction has been finished, the next instruction is inputted, the user cannot leave the system until all the desired instructions have been given, making the system difficult to use for the user. Therefore, the system is preferably designed to receive all the operations desired by the user at one time and execute the operations successively. With this arrangement, in the case when, for example, the user gives instructions to the system so as to warm a pizza in the refrigerator to be then eaten, it is only necessary for the user to preliminarily prepare the following two instructions (not shown).

Put a pizza stored in the refrigerator in the microwave oven to be warm.

Transfer the pizza in the microwave oven to the user (for example, to the table).

In other words, the system automatically performs the above operations while the user waits, for example, at the table, after the user has given the two instructions. As a result, this allows the user to spend time efficiently, and the user may do something else until the hot pizza is brought to the user at the table.

In this case, the system is preferably provided with a scheduling function for executing a plurality of processes efficiently. For example, in an attempt to take out a plurality of kinds of articles from a certain equipment and deliver to respectively different places, by carrying out only the taking-out process of the plurality of kinds of articles at one time, a well-scheduled system may be prepared so as to efficiently execute all the processes. For this purpose, the number of the arms 201 of the working robot 102 is not necessarily limited to one, and a plurality of arms may be prepared so as to simultaneously deal a plurality of articles at one time.

Here, the information presentation device 124 can display any kind of image information, as long as it can be multiplex-displayed on the actual environment image. For example, since the article mobile object database 107 manages the past positional history of the article and the mobile object together with the time, by giving such an instruction “things placed on the table at 14:00 yesterday”, it is possible to project images of the articles located on the table at that time onto the table at present. More specifically, the dinner at the same time on the same day last year can be displayed on the table so that the display can be used as a reference for the today's dinner.

Here, no limitation is given to the number of the information presentation devices 124, and when one information presentation device 124 is used, it is preferably designed so that upon receipt of a plurality of instructions, image presentations are carried out from the instruction having the highest order in preference successively. For example, numeric values indicating the order of preference are added as article attributes, and the processes may be executed from the article having the smallest value (article highest in preference) in succession. More specifically, smaller numeric values are put to important articles, such as wallets and keys, while greater numeric values are put to those articles that can be replaced by others, such as a remote controller of television.

In the case when a plurality of information presentation devices 124 are installed, presentation areas in charge within the environment may be assigned to the respective information presentation devices 124, or a plurality of instructions may be made to correspond to the respective information presentation devices 124. In this case also, when the number of instructions is greater than the number of the information presentation devices 124, the processes are preferably carried out in accordance with the order of preference. Here, when only one information presentation device 124 is prepared, areas in which a preferable image is not available due to shades of an equipment or a man tend to appear; however, in the case of a plurality of image presentation devices 124, preferable image presentation is given to even such areas.

In the above-mentioned embodiments, by irradiating a target article with light or the like, the user is informed of the existence position or the like of the article. However, the method of presenting information is not intended to be limited by this method. For example, when an article itself has a light-emitting function, the article itself may emit light. Moreover, not limited to methods of drawing attention of the user through the visual sense, the information presentation may be given by drawing attention through the other human senses, such as voice or vibrations. Here, in an attempt to show the existence position of the article, it is preferable to generate voice or the like from the existence position.

Here, the above-mentioned embodiments and modified examples thereof can be respectively achieved by using computer programs. A control program for the living assistance system, used for executing the living assistance system relating to the present invention, includes computer programs that execute a part of or all the operations of the aforementioned embodiments and the modified examples thereof.

Additionally, by properly combining the arbitrary embodiments of the aforementioned various embodiments, the effects possessed by the embodiments can be produced.

As described above, the present invention is effectively applied to a living assistance system that manages articles in a living environment such as a house and or office, for example, in a residential environment, so as to assist life and also to a controlling program for such a system.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A mobile robot system for managing an article located within a living environment, comprising:
an article robot database for storing at least information relating to an article located within the living environment and information relating to a robot capable of moving inside the living environment;
an environment map information database for storing information of structures of an equipment and a space inside the living environment;
a moving plan forming means for generating moving path information of the robot based upon information of the article robot database and information of the environment map information database, prior to movement of the robot to the article or to the equipment, or during the movement thereto; and
an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,
wherein the information presentation device changes a color of the moving path or the moving occupancy area in accordance with a speed at which the robot travels.

2. A mobile robot system for managing an article located within a living environment, comprising:
an article robot database for storing at least information relating to an article located within the living environment and information relating to a robot capable of moving inside the living environment;
an environment map information database for storing information of structures of an equipment and a space inside the living environment;
a moving plan forming means for generating moving path information of the robot based upon information of the article robot database and information of the environment map information database, prior to movement of the robot to the article or to the equipment, or during the movement thereto; and
an information presentation device for, based upon an inquiry concerning the article, directly outputting a moving path through which the robot travels and a moving occupancy area that is occupied by the robot upon the movement of the robot to the inside of the living environment, and then presenting the moving path and the moving occupancy area therein, by reference to the moving path information,
wherein the information presentation device presents the moving path and the moving occupancy area with a color of the moving path or the moving occupancy area changed in accordance with an arrival time of the movement of the robot to the article.

3. A mobile robot system comprising:
an environment map information database for storing information of structures of an equipment and a space within a living environment;
a robot capable of moving within the living environment;
a moving plan forming means for generating moving path information of the robot based upon information of the environment map information database, prior to movement of the robot to an article or to the equipment, or during the movement thereto; and
an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,
wherein the information presentation device presents the moving path and the moving occupancy area with a color of the moving path or the moving occupancy area changed in accordance with a speed at which the robot travels.

4. A mobile robot system comprising:
an environment map information database for storing information of structures of an equipment and a space within a living environment;
a robot capable of moving within the living environment;
a moving plan forming means for generating moving path information of the robot based upon information of the environment map information database, prior to movement of the robot to an article or to the equipment, or during the movement thereto; and
an information presentation device for, prior to the movement of the robot or during the movement thereof, directly outputting a moving path through which the robot travels and a moving occupancy area that is occupied by the robot upon the movement of the robot to the inside of the living environment, and then presenting the moving path and the moving occupancy area therein, based upon the moving path information generated by the moving plan forming means,
wherein the information presentation device presents the moving path and the moving occupancy area with a color of the moving path or the moving occupancy area changed in accordance with an arrival time of the movement of the robot to the article.

5. The mobile robot system according to claim 3, wherein
the information presentation means comprises:
a projection device for projecting an image pattern to the inside of the living environment; and
an adjusting means for providing an image pattern that is projected based upon the moving path information in such a manner that the path information and the moving occupancy area of the robot projected by the projection device based upon the moving path information and the moving path and the moving occupancy area through which the robot actually travels are made coincident with each other.

6. A mobile robot system comprising:
an environment map information database for storing information of structures of an equipment and a space within a living environment;
a robot capable of moving within the living environment, which has a grabbing unit capable of grabbing an article;
a robot grabbing area generation means for generating information of a grabbing feasible area that allows the robot to grab the article as a robot grabbing feasible area based upon information of the environment map information database; and
an information presentation device for directly presenting the robot grabbing feasible area generated by the robot grabbing area generation means to inside of the living environment,
wherein the robot grabbing feasible area is directly outputted to the inside of the living environment by the information presentation device to be presented therein.

7. The mobile robot system according to claim 1, wherein the information presentation device is installed in the robot.

8. The mobile robot system according to claim 2, wherein the equipment is prepared as an equipment for carrying out predetermined process on the article, and for automatically carrying out the predetermined process on the article when, after the equipment has been specified as a destination position of the article, the article is transferred to the equipment.

9. The mobile robot system according to claim 1, wherein the robot comprises an action plan forming means for forming an action plan which, when a sequence of operations are specified, is used for continuously carrying out the sequence of operations, and the robot is capable of automatically executing the sequence of operations in accordance with the action plan.

10. A program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to the article or to the equipment, or during the movement thereto, the program comprising:
a step of executing an operation in which, upon the movement of the robot, based upon the moving path information, the moving path and the moving occupancy area of the robot are directly presented in the living environment, with a color of the moving path or the moving occupancy area being changed in accordance with a speed at which the robot travels.

11. A program for controlling a mobile robot system comprising an environment map information database for storing information of structures of an equipment and a space within a living environment; a robot capable of moving within the living environment; an information presentation device for directly presenting information in the living environment; and a moving plan forming means for generating moving path information of the robot based upon information of the environment map information database, prior to movement of the robot to an article or to the equipment, or during the movement thereto, the program comprising:
a step of executing an operation in which, upon the movement of the robot, based upon the moving path information, the moving path and the moving occupancy area of the robot are directly presented in the living environment, with a color of the moving path or the moving occupancy area being changed in accordance with an arrival time of the movement of the robot to the article so as to be presented therein.
